(19) United States
(12) Patent Application Publication
(10) Pub. No.: US 2026/0059104 A1
(43) Pub. Date: Feb. 26, 2026

(54) LEARNING DEVICE, INFERENCE DEVICE, LEARNING METHOD, INFERENCE METHOD, ENCODING DEVICE, AND DECODING DEVICE

(71) Applicant: SONY SEMICONDUCTOR SOLUTIONS CORPORATION, KANAGAWA (JP)

(72) Inventors: Yoshinori ONO, KANAGAWA (JP); Takefumi NAGUMO, KANAGAWA (JP)

(21) Appl. No.: 19/104,356

(22) PCT Filed: Aug. 10, 2023
(86) PCT No.: PCT/JP2023/029239

§ 371 Date: Feb. 17, 2025

(30) Foreign Application Priority Data
Aug. 24, 2022 (JP) 2022-133611

(51) Int. Cl. H04N 19/117; H04N 19/159; H04N 19/169; H04N 19/182; H04N 19/80

(52) U.S. Cl. CPC H04N 19/117; H04N 19/159; H04N 19/182; H04N 19/1883; H04N 19/80

(57) ABSTRACT

A learning device according to the present disclosure includes: a first filter processing unit that performs component separation on frequency components included in reference pixels based on feature vectors of the reference pixels in the vicinity of a pixel to be predicted in image data; and a learning unit that learns a model that outputs a prediction value of the pixel to be predicted by using, as learning data, a set of a high-frequency vector, which is a feature vector of a high-frequency component among frequency components obtained by the component separation, and high-frequency information, which relates to a high-frequency component among frequency components included in the pixel to be predicted.

### FIELD

The present invention relates to a learning device, an inference device, a learning method, an inference method, an encoding device, and a decoding device.

### BACKGROUND

H.265/high efficiency video coding (HEVC) has been standardized as a compression encoding method for a moving image. H.265/HEVC uses intra prediction and inter prediction. In the intra prediction, a prediction value is generated by performing spatial prediction in an image. In the inter prediction, a prediction value is generated by performing motion compensation prediction between images.

For example, in Patent Literature 1, one encoding mode is determined from a plurality of encoding modes, that is, the first mode including run-length encoding, the second mode including weighted prediction encoding, and the third mode in which other encoding is performed. An image is encoded by using the determined encoding mode.

Furthermore, in Patent Literature 2, a predicted image is generated by using reference images and a generated model. The reference images are encoded frames among a plurality of frames constituting a video. The generated model is updated by machine learning.

Furthermore, in Patent Literature 3, a mode determination parameter for a first encoder is calculated by using a second encoder and a machine learning model. The parameter is used at the time of encoding an image block on the first encoder to reduce a calculation cost.

### CITATION LIST

### Patent Literature

Patent Literature 1: JP 2013-62752 A
Patent Literature 2: JP 2018-201117 A
Patent Literature 3: JP 2021-520082 A

### SUMMARY

### Technical Problem

By the way, it is known that an edge of an image has a high-frequency component. A problem of low prediction performance for an edge arises when a rule-based simple machine learning model is used. In proposed methods in Patent Literatures 1 to 3, models used for prediction are considered to be simple as described above. There is room for improvement in prediction performance.

Therefore, the present disclosure proposes a learning device, an inference device, a learning method, and an inference method capable of improving prediction performance in image compression.

### Solution to Problem

In order to solve the above problems, one aspect of A learning device comprising: a first filter processing unit that performs component separation on frequency components included in reference pixels based on feature vectors of the reference pixels in a vicinity of a pixel to be predicted in image data; and a learning unit that learns a model that outputs a prediction value of the pixel to be predicted by using, as learning data, a set of a high-frequency vector, which is a feature vector of a high-frequency component among frequency components obtained by the component separation, and high-frequency information, which relates to a high-frequency component among frequency components included in the pixel to be predicted.

Also, one aspect of An inference device that performs inference processing by using a learned model learned by a learning device, the inference device comprising: a second filter processing unit that performs component separation on frequency components included in reference pixels based on feature vectors of the reference pixels in a vicinity of a pixel to be predicted in image data; and an intra prediction unit that performs intra prediction for a pixel value of the pixel to be predicted based on a prediction value output by the learned model by using, as input, a high-frequency vector, which is a feature vector of a high-frequency component among frequency components obtained by the component separation.

### BRIEF DESCRIPTION OF DRAWINGS

FIG. 1 illustrates an example of a system according to embodiments.

FIG. 2 is an explanatory diagram outlining learning/inference processing.

FIG. 3 is a block diagram illustrating an overall configuration example of a learning instrument.

FIG. 4 is a block diagram illustrating an internal configuration example of an image scan unit.

FIG. 5 illustrates a specific example of an extraction method of extracting a reference range.

FIG. 6 is a block diagram illustrating an internal configuration example of a filter processing unit.

FIG. 7 illustrates an operation example of a learning unit.

FIG. 8 is a flowchart illustrating an operation procedure of filter processing.

FIG. 9 is a flowchart illustrating an operation procedure of learning processing.

FIG. 10 is a block diagram illustrating an overall configuration example of an inference instrument.

FIG. 11 illustrates an operation example of an inference unit.

FIG. 12 is a flowchart illustrating an operation procedure of preprocessing.

FIG. 13 is a flowchart illustrating an operation procedure of inference processing.

FIG. 14 is a block diagram illustrating an overall configuration example of an image encoding device.

FIG. 15 is a block diagram illustrating an internal configuration example of a prediction mode determination unit.

FIG. 16 is a block diagram illustrating a variation of the prediction mode determination unit.

FIG. 17 is a block diagram illustrating an internal configuration example of an intra prediction unit.

FIG. 18 is a flowchart illustrating an operation procedure of image encoding processing.

FIG. 19 is a block diagram illustrating an overall configuration example of an image decoding device.

FIG. 20 is a flowchart illustrating an operation procedure of image decoding processing.

FIG. 21 is a block diagram illustrating an internal configuration example (1) of a filter processing unit according to a variation of a first embodiment.

FIG. 22 is a block diagram illustrating an internal configuration example (2) of the filter processing unit according to the variation of the first embodiment.

FIG. 23 is a block diagram illustrating an overall configuration example of a learning instrument according to the variation of the first embodiment.

FIG. 24 is a block diagram illustrating an overall configuration example of an inference instrument according to the variation of the first embodiment.

FIG. 25 is a block diagram illustrating an overall configuration example of the learning instrument according to the variation of the first embodiment.

FIG. 26 is a block diagram illustrating an overall configuration example of an image encoding device according to a variation of a second embodiment.

FIG. 27 is a block diagram illustrating an overall configuration example of an image decoding device according to the variation of the second embodiment.

FIG. 28 is a block diagram illustrating a hardware configuration example of a computer corresponding to a device according to the embodiments and the variations of the present disclosure.

### DESCRIPTION OF EMBODIMENTS

Embodiments of the present disclosure will be described in detail below with reference to the drawings. Note that the embodiments do not limit a learning device, an inference device, a learning method, an inference method, an encoding device, and a decoding device according to the present disclosure. Furthermore, note that, in the following embodiments, the same reference signs are attached to the same parts to omit duplicate description.

### Embodiments

### 1. Introduction

In recent years, image sensors have increasingly addressed high resolution, high-speed imaging, and high dynamic ranges. This increases data amounts, and causes a problem of compression of I/F bands. Thus, there has been increased importance of highly efficient data compression mechanisms capable of being applied between an image sensor and a companion logic and between a logic and a DRAM, for example.

In image compression, a mechanism uses a method called intra prediction for predicting a certain pixel value with reference to surrounding pixels. The data amount can be compressed by transmitting only the difference between a predicted pixel value obtained by using the intra prediction and an actual pixel value. Thus, it is considered that compression efficiency can be improved since higher prediction accuracy of intra prediction reduces a difference value.

A large number of methods have been proposed for intra prediction. For example, in a prediction method based on a LOCO-I algorithm, a prediction value is calculated based on a rule-based mathematical model with reference to three pixels around a pixel to be predicted. There is, however, a problem of low performance of predicting an oblique edge/high frequency caused by a narrow reference range and a simple mathematical model.

Other examples include a machine learning/deep learning-based prediction method. For example, in MLP prediction using a multi-layer perceptron, a reference range is larger than that of the LOCO-I algorithm, and a mathematical model complicated more than a rule-based mathematical model is used, so that prediction accuracy can be improved.

The MLP prediction is similar to the LOCO-I algorithm in that pixels around a pixel to be predicted are referred to and a prediction value is calculated from a group of the pixels. Unlike the rule-based mathematical model, however, in the MLP prediction, a reference direction and a reference number can be freely set as far as an already predicted pixel is concerned. Thus, it is also possible to create a reference biased in a specific direction such as horizontal/vertical directions.

Here, the MLP prediction may use a method of inputting, as a feature amount to a model, the differences between a value of a left pixel adjacent to a pixel to be predicted and all pixels within a reference range, performing learning and prediction operation, and adding the value of the adjacent left pixel to a prediction result. This enables model generation in a state in which a DC component of each pixel is canceled, so that a more efficient learning result can be acquired.

In contrast, in the above-described method, only the adjacent left component is considered, which strengthens the correlation with the horizontal direction as viewed from the pixel to be predicted and deteriorates the prediction accuracies of pixels in the vertical direction. In such a case, a lot of compression noise may be generated in a steep edge region in the vertical direction.

From the above, the conventional technique has a problem of low encoding efficiency (i.e., low prediction performance), and has room for improvement.

Therefore, in order to solve the above-described problem, the learning device according to the proposed technique of the present disclosure performs component separation on frequency components included in reference pixels based on feature vectors of the reference pixels in the vicinity of a pixel to be predicted included in image data. According to such a learning device, a model that outputs a prediction value of a pixel to be predicted is learned by using, as learning data, a set of a high-frequency vector and high-frequency information. The high-frequency vector is a feature vector of a high-frequency component among frequency components obtained by component separation. The high-frequency information relates to a high-frequency component among frequency components included in the pixel to be predicted.

### 2. System Configuration

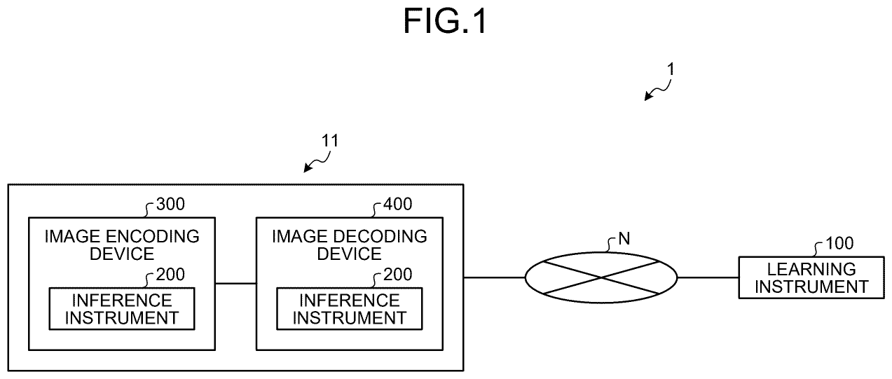

Next, a configuration of a system according to the embodiments will be described with reference to FIG. 1. FIG. 1 illustrates an example of the system according to the embodiments. FIG. 1 illustrates an image processing system 1 in the example of the system according to the embodiments.

As illustrated in FIG. 1, the image processing system 1 includes a learning instrument 100, an image encoding device 300, and an image decoding device 400.

Furthermore, according to an example of FIG. 1, the image processing system 1 includes an image processing system 11 including the image encoding device 300 and the image decoding device 400.

For example, in the image processing system 11, an image captured by an imaging device (not illustrated) is input to the image encoding device 300. The image encoding device 300 encodes the image to generate encoded data. This causes the encoded data to be transmitted as a bit stream from the image encoding device 300 to the image decoding device 400 in the image processing system 11. Then, in the image processing system 11, the image decoding device 400 decodes the encoded data to generate an image, and the image is displayed on a display device (not illustrated).

Furthermore, the learning instrument 100 is an example of the learning device in the present disclosure. Although FIG. 1 illustrates an example in which the learning instrument 100 is a server device in a cloud for the image processing system 11, for example, a configuration in which the learning instrument 100 is mounted on the image encoding device 300 as a module may be adopted.

Inference instruments 200 are examples of the inference device in the present disclosure. As illustrated in FIG. 1, the inference instruments 200 may be mounted on the image encoding device 300 and the image decoding device 400 as modules.

In the following description, the embodiments are separated into a first embodiment and a second embodiment. Specifically, in the first embodiment, configurations/operations of the learning instrument 100 and the inference instruments 200 will be described in detail. Furthermore, in the second embodiment, configurations/operations of the image encoding device 300 and the image decoding device 400 mounted with the inference instruments 200 will be described in detail.

### 1. First Embodiment

### 1-1. Outline of Learning/Inference Processing

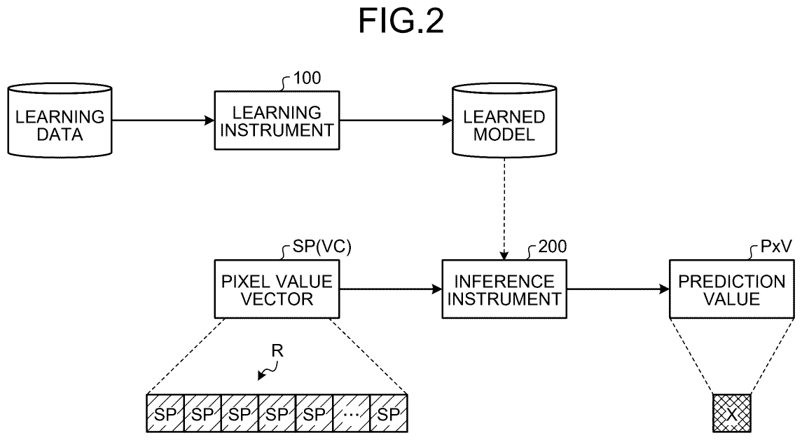

Subsequently, processing performed between the learning instrument 100 and an inference instrument 200, that is, learning/inference processing will be outlined with reference to FIG. 2. FIG. 2 is an explanatory diagram outlining the learning/inference processing.

According to an example of FIG. 2, the learning instrument 100 generates a model used in intra prediction executed by the image encoding device 300 and the image decoding device 400. For example, the learning instrument 100 generates a model that has learned a parameter of a neural network model by adjusting the parameter. For example, the learning instrument 100 executes learning processing of machine learning by using learning data. As a result, a learned model is obtained.

Although, in the embodiment, the learning instrument 100 generates a model by using a neural network as a learning algorithm, a usable learning algorithm is not limited to the neural network. For example, the learning instrument 100 may generate a model by using a learning algorithm such as a support vector machine, clustering, and reinforcement learning. That is, the learning instrument 100 may use any machine learning method in model generation.

Furthermore, the inference instrument 200 uses the learned model generated by the learning instrument 100. Specifically, the inference instrument 200 calculates a prediction value PxV of a pixel X to be predicted by using a machine learning model, which has been developed from a learned model by inputting pixel value vectors of specific reference pixels related to the pixel X to be predicted. More specifically, the inference instrument 200 inputs pixel value vectors SP(VC) of reference pixels SP within a reference range R to the learned model. Then, the inference instrument 200 performs predetermined processing on a model prediction value PV output by the model to perform intra prediction for a pixel value of the pixel X to be predicted, and acquires the result as the prediction value PxV.

### 1-2. Configuration Example/Operation Example of Learning Instrument 100

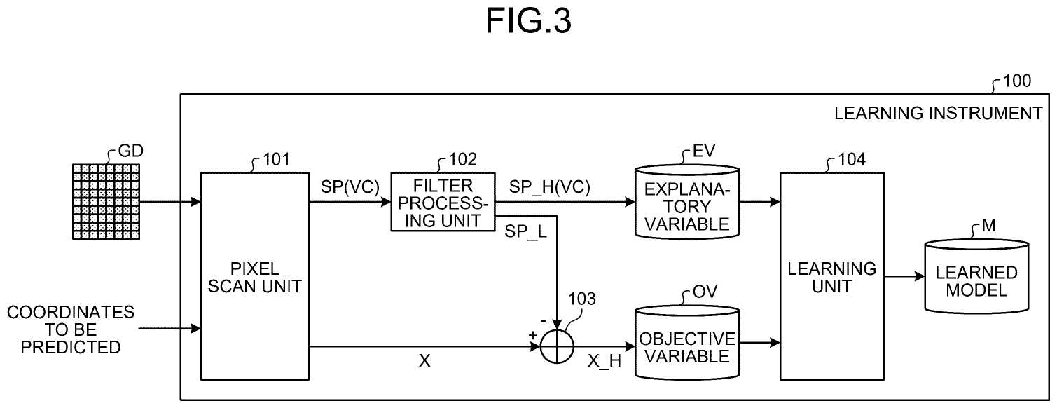

A configuration example and an operation example of the learning instrument 100 will now be described with reference to FIGS. 3 to 7. Note that FIGS. 3 to 7 mainly illustrate processing units, data flows, and the like. FIGS. 3 to 7 do not necessarily illustrate all. That is, the learning instrument 100 may include a processing unit not illustrated as a block in FIGS. 3 to 7. There may be processing and data flows not illustrated as an arrow and the like in FIGS. 3 to 7.

### 1-3. Overall Configuration Example of Learning Instrument 100

FIG. 3 is a block diagram illustrating an overall configuration example of the learning instrument 100. According to an example of FIG. 3, the learning instrument 100 includes a pixel scan unit 101, a filter processing unit 102, a difference calculation unit 103, and a learning unit 104.

### Pixel Scan Unit 101

The pixel scan unit 101 acquires the pixel X to be predicted and the reference pixels SP based on original image data GD and coordinates to be predicted, which indicate position coordinates of the pixel to be predicted in the original image data GD. Specifically, the pixel scan unit 101 extracts, as the pixel X to be predicted, one pixel at a position defined by the coordinates to be predicted in the original image data GD. Furthermore, the pixel scan unit 101 determines the reference range R in the original image data GD based on the coordinates to be predicted, and extracts pixels within the determined reference range R as the reference pixels SP. Furthermore, the pixel scan unit 101 calculates the pixel value vectors SP(VC) from the reference pixels SP.

Furthermore, the pixel scan unit 101 transmits the pixel value vectors SP(VC) to the filter processing unit 102, and transmits the pixel X to be predicted to the difference calculation unit 103.

### Filter Processing Unit 102

When receiving the pixel value vectors SP(VC), the filter processing unit 102 executes component separation on frequency components included in the reference pixels SP based on the pixel value vectors SP(VC). For example, the filter processing unit 102 calculates filter information from the pixel value vectors SP(VC), and separates high-frequency components SP_H and low-frequency components SP_L by using the calculated filter information.

Then, the filter processing unit 102 acquires high-frequency vectors SP_H(VC), and transmits the high-frequency vectors SP_H(VC) to the learning unit 104. The high-frequency vectors SP_H(VC) are pixel value vectors of the high-frequency components SP_H. As illustrated in FIG. 3, the high-frequency vectors SP_H(VC) are used as explanatory variables EV in the learning processing performed by the learning unit 104. Furthermore, the filter processing unit 102 transmits the low-frequency components SP_L to the difference calculation unit 103.

### Difference Calculation Unit 103

The difference calculation unit 103 acquires the high-frequency component X_H of the pixel X to be predicted by subtracting the low-frequency components SP_L transmitted by the filter processing unit 102 from the frequency components included in the pixel X to be predicted, which has been transmitted by the pixel scan unit 101. The high-frequency component X_H is used as an objective variable OV in the learning processing performed by the learning unit 104.

### Learning Unit 104

The learning unit 104 executes learning processing related to the neural network model based on learning data in which the high-frequency vectors SP_H(VC) are used as the explanatory variables EV and the high-frequency component X_H is used as the objective variable OV. Specifically, the learning unit 104 updates a parameter (e.g., weight and bias) of the neural network model based on the learning data, and generates a model which is a learning result. This causes the learning unit 104 to obtain a learned model M.

### 1-4. Internal Configuration Example of Pixel Scan Unit 101

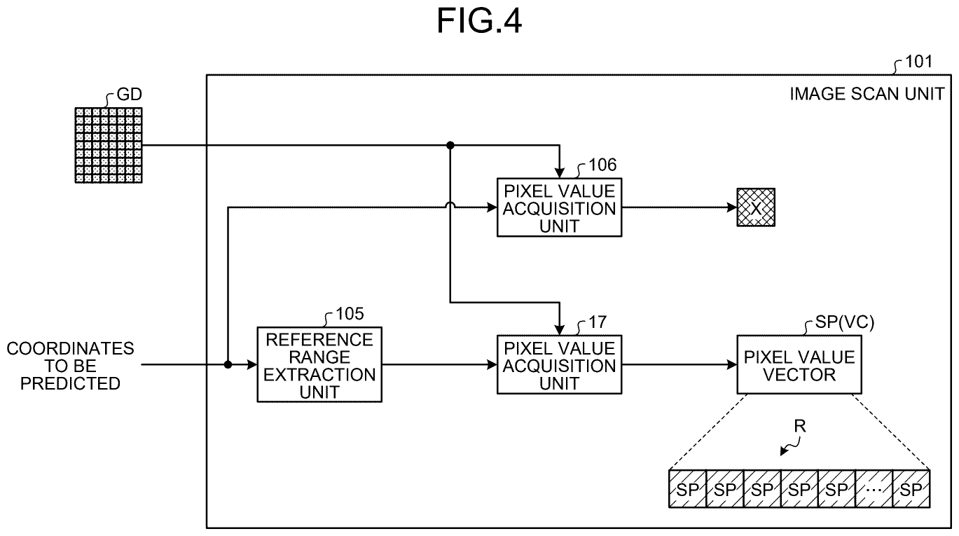

Next, the pixel scan unit 101 in FIG. 3 will be described more specifically with reference to FIG. 4. FIG. 4 is a block diagram illustrating an internal configuration example of the pixel scan unit 101. According to an example of FIG. 4, the pixel scan unit 101 includes a reference range extraction unit 105, a pixel value acquisition unit 106, and a pixel value acquisition unit 107.

### Reference Range Extraction Unit 105

The reference range extraction unit 105 extracts the reference range R based on the coordinates to be predicted, which indicate the position coordinates of the pixel to be predicted in the original image data GD. For example, the reference range extraction unit 105 determines position coordinates relative to the coordinates to be predicted, and extracts a pixel group corresponding to the determined position coordinates as the reference range R.

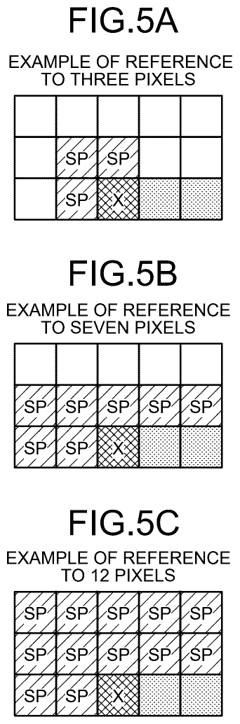

Here, a specific example of a method of extracting the reference range R will be described with reference to FIG. 5. FIG. 5 illustrates a specific example of an extraction method of extracting the reference range R. First, FIG. 5 illustrates an example in which the position coordinates of one candidate pixel (pixel with “X”) to be acquired as the pixel X to be predicted are designated. In such a state, the reference range extraction unit 105 can adopt one of extraction methods of three patterns of FIG. 5(a) to 5(c).

For example, when the position coordinates of one candidate pixel are determined, the reference range extraction unit 105 may refer to a total of three pixels, that is, one pixel in the left direction from the position coordinates, one pixel in the upper direction, and one pixel in the upper left direction, as illustrated in FIG. 5(a). The reference range extraction unit 105 may extract a range of the three pixels referred to as the reference range R.

Furthermore, when the position coordinates of one candidate pixel are determined, the reference range extraction unit 105 may refer to a total of seven pixels, that is, two pixels (two locations) in the left direction from the position coordinates, one pixel (one location) in the upper direction of X, and two pixels each in the right and left directions from the pixel (four locations), as illustrated in FIG. 5(b). The reference range extraction unit 105 may extract a range of the seven pixels referred to as the reference range R.

Furthermore, when the position coordinates of one candidate pixel are determined, the reference range extraction unit 105 may refer to a total of 12 pixels, that is, two pixels (two locations) in the left direction from the position coordinates, one pixel (one location) in the upper direction of X, two pixels each in the right and left directions from the pixel (four locations), and one pixel (one location) in still the upper direction of X, and two pixels each in the right and left directions from the pixel (four locations), as illustrated in FIG. 5(c). The reference range extraction unit 105 may extract a range of the 12 pixels referred to as the reference range R.

Returning to FIG. 4, the reference range extraction unit 105 transmits the position coordinates of one candidate pixel (pixel with “X”) acquired as the pixel X to be predicted to the pixel value acquisition unit 106, and transmits the reference range R extracted by the method described in FIG. 5 to the pixel value acquisition unit 107. Note that, as described with reference to FIG. 5, the reference range R can be said as coordinate information defined by position coordinates relative to the position coordinates of one candidate pixel.

### Pixel Value Acquisition Unit 106

The pixel value acquisition unit 106 acquires one pixel at a position defined by the position coordinates of one candidate pixel in the original image data GD, and determines the acquired one pixel as the pixel X to be predicted. Furthermore, the pixel value acquisition unit 106 may transmit the pixel X to be predicted to the difference calculation unit 103.

### Pixel Value Acquisition Unit 107

The pixel value acquisition unit 107 acquires pixels at positions defined by the reference range R in the original image data GD, and determines the acquired pixels as the reference pixels SP. Furthermore, the pixel value acquisition unit 107 calculates the pixel value vectors SP(VC) for the reference pixels SP.

For example, when the pattern of FIG. 5(a) is adopted, the pixel value acquisition unit 107 acquires three pixels within the reference range R, and determines the pixels as the reference pixels SP. Then, the pixel value acquisition unit 107 calculates the pixel value vectors SP(VC) for the three reference pixels SP.

Furthermore, when the pattern of FIG. 5(b) is adopted, the pixel value acquisition unit 107 acquires seven pixels within the reference range R, and determines the pixels as the reference pixels SP. Then, the pixel value acquisition unit 107 calculates the pixel value vectors SP(VC) for the seven reference pixels SP.

Furthermore, when the pattern of FIG. 5(c) is adopted, the pixel value acquisition unit 107 acquires 12 pixels within the reference range R, and determines the pixels as the reference pixels SP. Then, the pixel value acquisition unit 107 calculates the pixel value vectors SP(VC) of the 12 reference pixels SP.

Furthermore, the pixel value acquisition unit 107 may transmit the pixel value vectors SP(VC) to the filter processing unit 102.

### 1-5. Internal Configuration Example of Filter Processing Unit 102

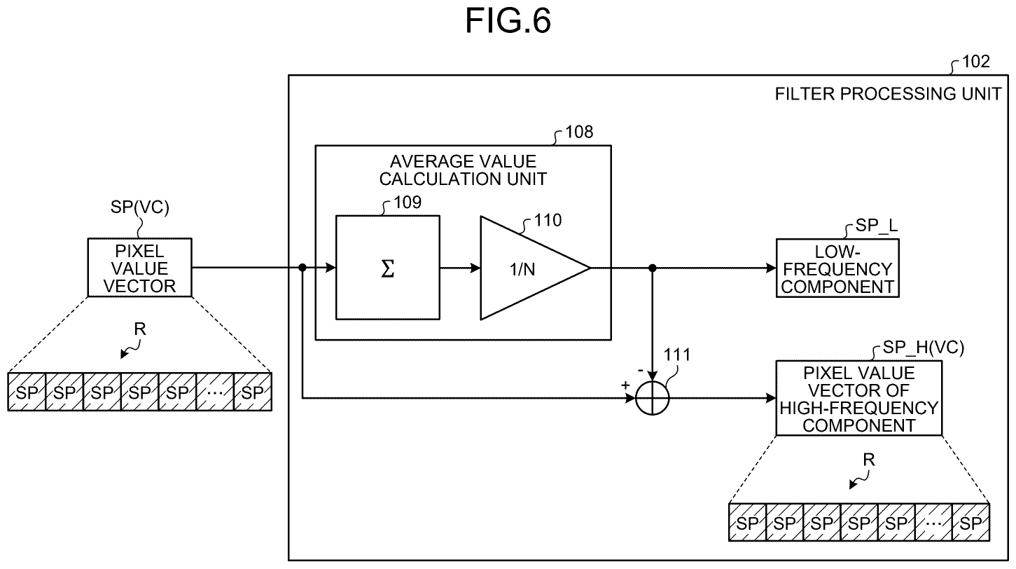

Next, the filter processing unit 102 in FIG. 3 will be described more specifically with reference to FIG. 6. FIG. 6 is a block diagram illustrating an internal configuration example of the filter processing unit 102. According to an example of FIG. 6, the filter processing unit 102 may include a representative value calculation unit 108 and an addition unit 111. The representative value calculation unit 108 may further include a summing unit 109 and a division unit 110.

### Representative Value Calculation Unit 108

The representative value calculation unit 108 calculates a representative value representing the pixel value vectors SP(VC) from the pixel value vectors SP(VC) transmitted by the pixel value acquisition unit 107, and separates the calculated representative value as a low-frequency component SP_L among frequency components included in the reference pixels SP.

For example, the representative value calculation unit 108 may calculate an average value of the pixel value vectors SP(VC) of the reference pixels SP as a representative value representing the pixel value vectors SP(VC). In contrast, the representative value calculation unit 108 may calculate a median of the pixel value vectors SP(VC) as a representative value, or may acquire the minimum value of the pixel value vectors SP(VC) as a representative value. In the following description, the representative value calculation unit 108 calculates an average value of the pixel value vectors SP(VC) of the reference pixels SP, and acquires the average value as a representative value.

### Summing Unit 109

The summing unit 109 calculates the sum Σ of the pixel value vectors SP(VC) transmitted by the pixel value acquisition unit 107, that is, the pixel value vectors SP(VC) of the reference pixels SP.

### Division Unit 110

The division unit 110 calculates an average value Σ/N of the pixel value vectors SP(VC) of N reference pixels SP by dividing the sum Σ calculated by the summing unit 109 by the number N of the reference pixels SP. Then, the division unit 110 separates the average value Σ/N as a low-frequency component SP_L among frequency components included in the reference pixels SP.

For example, when the pattern of FIG. 5(a) is adopted, three reference pixels SP are obtained. The division unit 110 thus calculates the average value Σ/N by dividing the sum Σ obtained by adding the pixel value vectors SP(VC) of the three reference pixels SP by the number N (N=3) of pixels. Then, the division unit 110 separates the average value Σ/N as a low-frequency component SP_L of each of the three reference pixels SP.

Furthermore, when the pattern of FIG. 5(b) is adopted, seven reference pixels SP are obtained. The division unit 110 thus calculates the average value Σ/N by dividing the sum Σ obtained by adding the pixel value vectors SP(VC) of the seven reference pixels SP by the number N (N=7) of pixels. Then, the division unit 110 separates the average value Σ/N as a low-frequency component SP_L of each of the seven reference pixels SP.

Furthermore, when the pattern of FIG. 5(c) is adopted, 12 reference pixels SP are obtained. The division unit 110 thus calculates the average value Σ/N by dividing the sum Σ obtained by adding the pixel value vectors SP(VC) of the 12 reference pixels SP by the number N (N=12) of pixels. Then, the division unit 110 separates the average value Σ/N as a low-frequency component SP_L of each of the 12 reference pixels SP.

Furthermore, the division unit 110 may transmit the separated low-frequency components SP_L to the difference calculation unit 103. Note that, according to the above-described example, the low-frequency components SP_L are obtained not as vectors but as mere scalar values. Furthermore, the division unit 110 may transmit the separated low-frequency components SP_L also to the addition unit 111.

### Addition Unit 111

The addition unit 111 separates the high-frequency components SP_H from the reference pixels SP by executing filter processing on the pixel value vectors SP(VC) of the reference pixels SP. In the filter processing, the low-frequency components SP_L (average value Σ/N) are applied as filter information.

For example, the addition unit 111 may subtract the low-frequency components SP_L from frequency components of N reference pixels SP, and separate the differences obtained by the subtraction as the high-frequency components SP_H of the reference pixels SP. Furthermore, the addition unit 111 calculates the high-frequency vectors SP_H(VC), which are the pixel value vectors of the high-frequency components SP_H, based on the pixel value vectors SP(VC) of the reference pixels SP on which the separation has been executed and the high-frequency components SP_H of the reference pixels SP, and transmits the high-frequency vectors SP_H(VC) to the learning unit 104 as explanatory variables.

For example, when the pattern of FIG. 5(a) is adopted, the addition unit 111 may subtract the low-frequency components SP_L corresponding to three reference pixels SP from frequency components of the reference pixels SP, and separate the differences obtained by the subtraction as the high-frequency components SP_H of the reference pixels SP. Furthermore, the addition unit 111 calculates the high-frequency vectors SP_H(VC) corresponding to the three reference pixels SP based on the pixel value vectors SP(VC) and the high-frequency components SP_H of the reference pixels SP.

Furthermore, when the pattern of FIG. 5(b) is adopted, the addition unit 111 may subtract the low-frequency components SP_L corresponding to seven reference pixels SP from frequency components of the reference pixels SP, and separate the differences obtained by the subtraction as the high-frequency components SP_H of the reference pixels SP. Furthermore, the addition unit 111 calculates the high-frequency vectors SP_H(VC) corresponding to the seven reference pixels SP based on the pixel value vectors SP(VC) and the high-frequency components SP_H of the reference pixels SP.

Furthermore, when the pattern of FIG. 5(c) is adopted, the addition unit 111 may subtract the low-frequency components SP_L corresponding to 12 reference pixels SP from frequency components of the reference pixels SP, and separate the differences obtained by the subtraction as the high-frequency components SP_H of the reference pixels SP. Furthermore, the addition unit 111 calculates the high-frequency vectors SP_H(VC) corresponding to the 12 reference pixels SP based on the pixel value vectors SP(VC) and the high-frequency components SP_H of the reference pixels SP.

Here, in the above-described filter processing, the filter processing unit 102 performs component separation into two frequency bands. Specifically, the frequency components included in the reference pixels SP are subjected to component separation into components in a high-frequency band and components in a low-frequency band.

The filter processing unit 102 may, however, perform component separation into three frequency bands. Specifically, the frequency components included in the reference pixels SP may be subjected to component separation into components in a high-frequency band, components in a medium-frequency band, and components in a low-frequency band. Specific examples of the variations will be described below.

For example, in a method of a variation, the high-frequency vector SP_H(VC) obtained by the method of performing component separation into two frequency bands continues to be used. A part of the high-frequency components SP_H is separated as medium frequency components SP_M. Medium frequency vectors SP_M(VC), which are pixel value vectors of the medium frequency components SP_M, are utilized as explanatory variables.

For example, according to the variation, the summing unit 109 calculates the sum Σm of the high-frequency vectors SP_H(VC) calculated for N reference pixels SP. Furthermore, the division unit 110 calculates an average value Σm/N of the high-frequency vectors SP_H(VC) of the N reference pixels SP by dividing the sum Σm by the number N of the reference pixels SP. Then, the division unit 110 separates the average value Σm/N as a second frequency component SP_H2 among frequency components included in the reference pixels SP.

Furthermore, the addition unit 111 separates the medium frequency components SP_M from the reference pixels SP by executing filter processing on the high-frequency vectors SP_H(VC) of the reference pixels SP. In the filter processing, second frequency components SP_H2 (average value Σm/N) are applied as filter information.

For example, the addition unit 111 may subtract the second frequency components SP_H2 from frequency components of N reference pixels SP, and separate the differences obtained by the subtraction as the medium frequency components SP_M of the reference pixels SP. Furthermore, the addition unit 111 calculates the medium frequency vectors SP_M(VC), which are the pixel value vectors of the medium-frequency components SP_H, based on the pixel value vectors SP(VC) of the reference pixels SP on which the separation has been executed and the medium frequency components SP_M of the reference pixels SP, and transmits the medium frequency vectors SP_M(VC) to the learning unit 104 as explanatory variables.

According to such a variation, the medium frequency vectors SP_M(VC) are regarded as information corresponding to the high-frequency vectors SP_H(VC), and are used as explanatory variables instead of the high-frequency vectors SP_H(VC).

### 1-6. Operation Example of Learning Unit 104

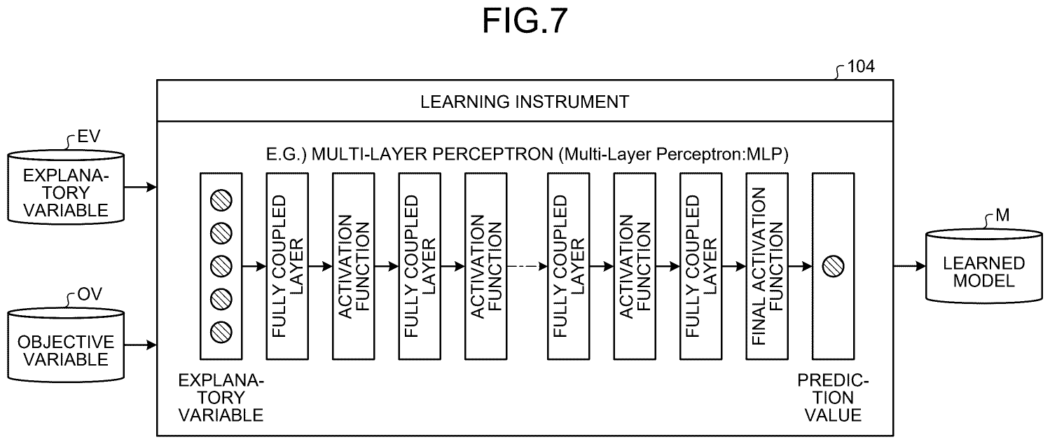

Next, the learning unit 104 in FIG. 3 will be described more specifically with reference to FIG. 7. FIG. 7 illustrates an operation example of the learning unit 104.

For example, the learning unit 104 executes learning processing using a multi-layer perceptron (MLP) as a neural network model. Specifically, when the addition unit 111 transmits the high-frequency vectors SP_H(VC) and the difference calculation unit 103 transmits the high-frequency component X_H, the learning unit 104 executes learning processing by using a set of one high-frequency vector SP_H(VC) and the high-frequency component X_H as learning data.

Specifically, the learning unit 104 uses the high-frequency vector SP_H(VC) as an explanatory variable, and uses the high-frequency component X_H as an objective variable in the learning data. As illustrated in FIG. 7, the learning unit 104 thereby optimizes parameters (e.g., weight) of layers by using an inverse error propagation method. Then, the learning unit 104 generates the learned model M in which the parameters have been learned as a learning result obtained by performing the designated number of times of learning processing on all pieces of input data. In the learned model M, a prediction value of the pixel X to be predicted is output.

Note that, when the medium frequency components SP_M are separated, the learning unit 104 may use the medium frequency vectors SP_M(VC), which are pixel value vectors of the medium frequency components SP_H, as objective variables instead of the high-frequency vectors SP_H(VC).

### 1-7. Procedure of Filter Processing

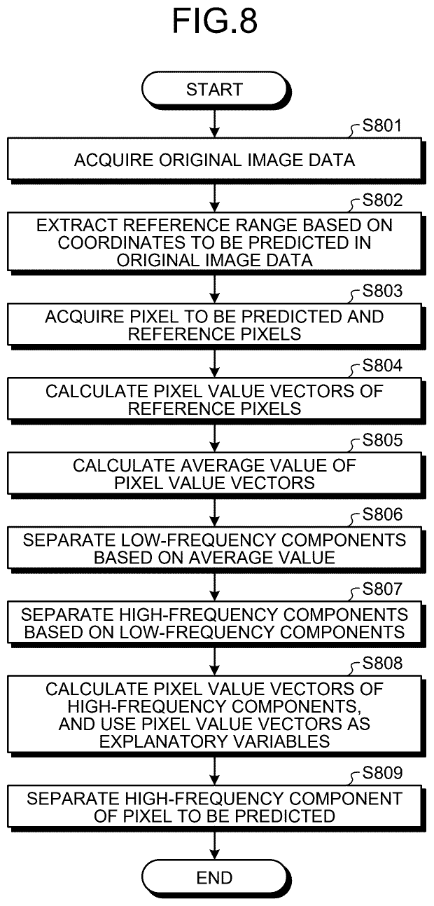

An operation procedure of the filter processing executed by the learning instrument 100 will now be described with reference to FIG. 8. FIG. 8 is a flowchart illustrating the operation procedure of the filter processing.

First, the pixel scan unit 101 acquires the original image data GD (Step S801). For example, when an image captured by the imaging device is input to the image encoding device 300, the pixel scan unit 101 may acquire the input captured image as original image data from the image encoding device 300.

Next, the reference range extraction unit 105 extracts the reference range R based on coordinates to be predicted, which have been designated in the original image data GD (Step S802). For example, the reference range extraction unit 105 determines position coordinates relative to the coordinates to be predicted, and extracts a pixel group corresponding to the determined position coordinates as the reference range R.

Next, the pixel scan unit 101 acquires the pixel X to be predicted and the reference pixels SP (Step S803). For example, the pixel value acquisition unit 106 acquires a pixel at a position defined by the coordinates to be predicted in the original image data GD, and determines the acquired pixel as the pixel X to be predicted. Furthermore, the pixel value acquisition unit 107 acquires pixels at positions defined by the reference range R in the original image data GD, and determines the acquired pixels as the reference pixels SP. In the following description, it is assumed that N reference pixels SP are acquired.

Therefore, the pixel value acquisition unit 107 calculates the pixel value vectors SP(VC) of the N reference pixels SP (Step S804).

The representative value calculation unit 108 calculates an average value of the pixel value vectors SP(VC) of the reference pixels SP as a representative value representing the pixel value vectors SP(VC) (Step S805). For example, the summing unit 109 calculates the sum Σ of the pixel value vectors SP(VC) of the reference pixels SP. Then, the division unit 110 calculates the average value Σ/N of the pixel value vectors SP(VC) of N reference pixels SP by dividing the sum Σ by the number N of the reference pixels SP.

Furthermore, the division unit 110 separates the low-frequency components SP_L among frequency components included in the reference pixels SP based on the average value Σ/N (Step S806). For example, the division unit 110 separates the average value Σ/N as a low-frequency component SP_L among frequency components included in the reference pixels SP. The low-frequency components SP_L are transmitted to the difference calculation unit 103.

The addition unit 111 separates the high-frequency components SP_H among frequency components included in the reference pixels SP based on the low-frequency components SP_L (Step S807). For example, the addition unit 111 subtracts the low-frequency components SP_L from frequency components of N reference pixels SP, and separates the differences obtained by the subtraction as the high-frequency components SP_H of the reference pixels SP.

Furthermore, the addition unit 111 calculates the high-frequency vectors SP_H(VC), which are the pixel value vectors of the high-frequency components SP_H, based on the pixel value vectors SP(VC) of the reference pixels SP and the high-frequency components SP_H of the reference pixels SP, and transmits the high-frequency vectors SP_H(VC) to the learning unit 104 as explanatory variables (Step S808).

The difference calculation unit 103 separates the difference obtained by subtracting the low-frequency components SP_L from frequency components included in the pixel X to be predicted as the high-frequency component X_H of the pixel X to be predicted, and transmits the high-frequency component X_H of the pixel X to be predicted to the learning unit 104 as an objective variable (Step S809).

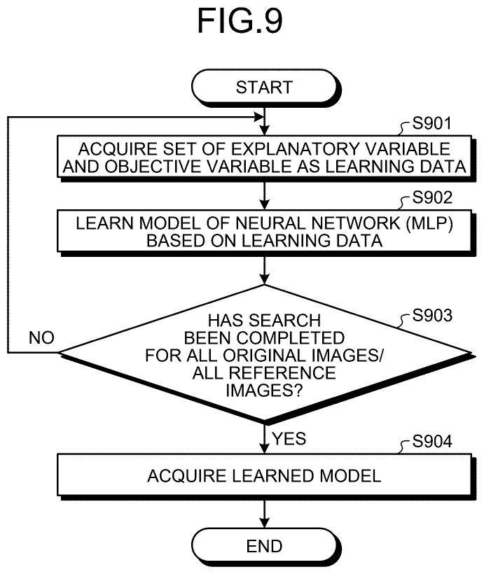

According to the above-described filter processing, the learning unit 104 can obtain a set of an explanatory variable EV and the objective variable OV as one piece of learning data. A high-frequency vector SP_H(VC) of each of N reference pixels SP is used as the explanatory variable EV. The high-frequency component X_H of the pixel X to be predicted is used as the objective variable OV. In FIG. 9 next, an operation procedure of the learning processing using the learning data will be described.

### 1-8. Procedure of Learning Processing

An operation procedure of the learning processing executed by the learning instrument 100 will be described with reference to FIG. 9. FIG. 9 is a flowchart illustrating the operation procedure of the learning processing.

First, the learning unit 104 acquires learning data in which the high-frequency vectors SP_H(VC) are used as the explanatory variables EV and the high-frequency component X_H is used as the objective variable OV (Step S901).

Next, the learning unit 104 executes learning processing for parameters in a model of the multi-layer perceptron (MLP) (Step S902).

Furthermore, the learning unit 104 determines whether or not the search has been completed for all pieces of the original image data GD and all the reference images SP in performing the designated number of times of learning processing (Step S903).

When the learning unit 104 determines that the search has not been completed (Step S903; No), the processing proceeds to Step S901.

### 1-9. Configuration Example/Operation Example of Inference Instrument 200

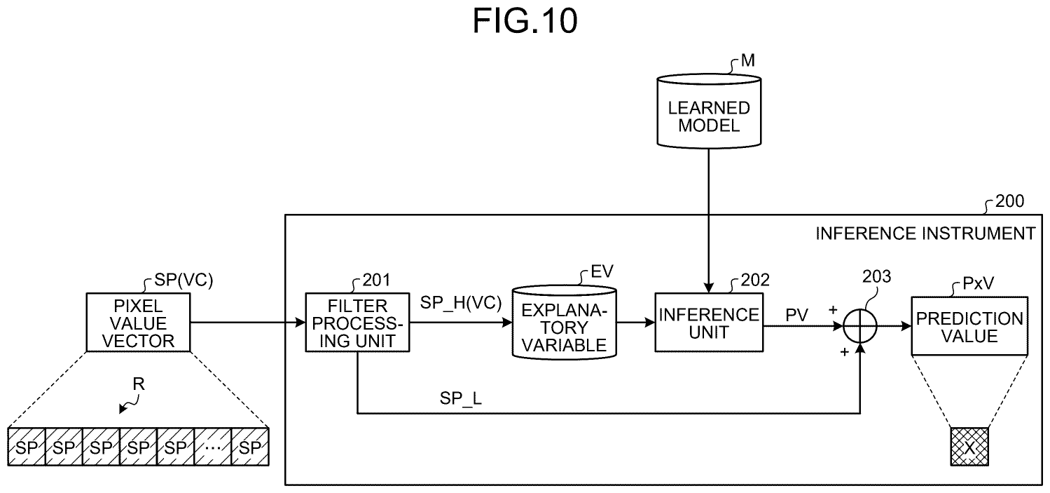

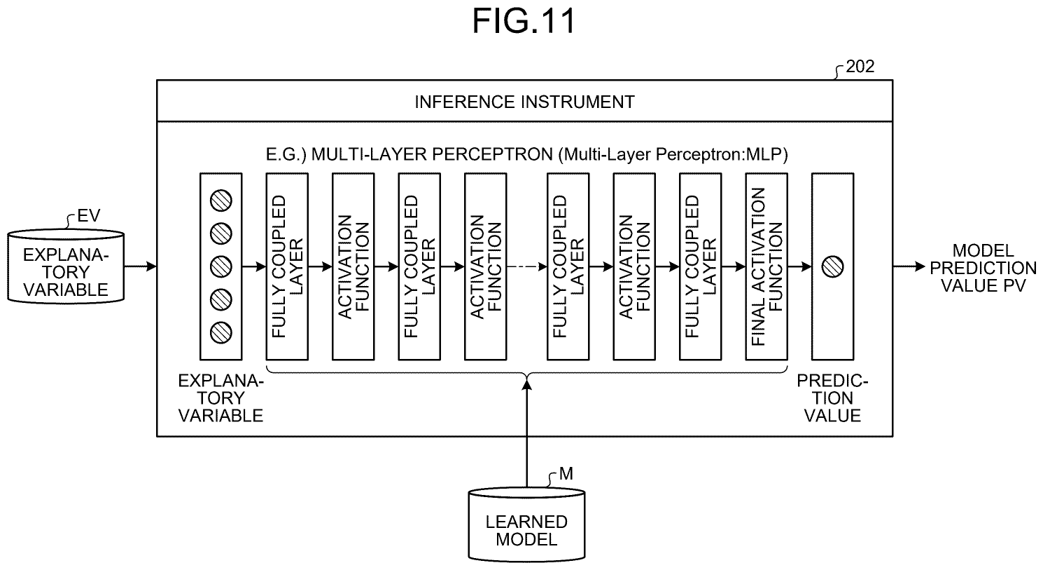

A configuration example and an operation example of the inference instrument 200 will now be described with reference to FIGS. 10 and 11. Note that FIGS. 10 and 11 mainly illustrate processing units, data flows, and the like. FIGS. 10 and 11 do not necessarily illustrate all. That is, the inference instrument 200 may include a processing unit not illustrated as a block in FIGS. 10 and 11. There may be processing and data flows not illustrated as an arrow and the like in FIGS. 10 and 11.

Furthermore, the inference instrument 200 calculates an intra prediction value by executing inference processing in machine learning. For example, when the pixel value vectors SP(VC) of the reference pixels SP within the reference range R are transmitted, the inference instrument 200 performs component separation on frequency components included in the reference pixels SP into the high-frequency components SP_H and the low-frequency components SP_L by performing filter processing on the reference pixels SP. Then, the inference instrument 200 inputs the high-frequency vectors SP_H(VC), which are pixel value vectors of the high-frequency components SP_H, to the learned model M, and adds the low-frequency components SP_L to the model prediction value PV output from the learned model M. The inference instrument 200 acquires the result as the final intra prediction value PxV. In the following description, the inference instrument 200 will be described more specifically.

### 1-10. Overall Configuration Example of Inference Instrument 200

FIG. 10 is a block diagram illustrating an overall configuration example of the inference instrument 200. According to an example of FIG. 10, the inference instrument 200 includes a filter processing unit 201, an inference unit 202, and an addition unit 203.

### Filter Processing Unit 201

The filter processing unit 201 has a function equivalent to that of the filter processing unit of the learning instrument 100. For example, when the pixel value vectors SP(VC) of N reference pixels SP within the reference range R are transmitted, the filter processing unit performs component separation on frequency components included in the reference pixels SP based on the pixel value vectors SP(VC). Specifically, the filter processing unit 201 calculates filter information from the pixel value vectors SP(VC), and separates the high-frequency components SP_H and the low-frequency components SP_L by using the calculated filter information.

For example, the filter processing unit 201 calculates the average value Σ/N of the pixel value vectors SP(VC) from the pixel value vectors SP(VC) of the N reference pixels SP, and separates the calculated average value Σ/N as a low-frequency component SP_L of each of the N reference pixels SP.

Furthermore, the filter processing unit 201 separates the high-frequency components SP_H from the reference pixels SP by executing filter processing on the pixel value vectors SP(VC) of the reference pixels SP. In the filter processing, the low-frequency components SP_L (average value Σ/N) are applied as filter information. For example, the filter processing unit 201 may subtract the low-frequency components SP_L from frequency components of N reference pixels SP, and separate the differences obtained by the subtraction as the high-frequency components SP_H of the reference pixels SP.

Furthermore, the filter processing unit 201 calculates the high-frequency vectors SP_H(VC), which are the pixel value vectors of the high-frequency components SP_H, based on the pixel value vectors SP(VC) of the reference pixels SP on which the separation has been executed and the high-frequency components SP_H of the reference pixels SP, and transmits the high-frequency vectors SP_H(VC) to the inference unit 202 as explanatory variables. As a result, the inference unit 202 can perform inference processing by using the high-frequency vectors SP_H(VC) of the N reference pixels SP as objective variables.

Here, in the above-described filter processing, the filter processing unit 201 performs component separation into two frequency bands. Specifically, the frequency components included in the reference pixels SP are subjected to component separation into components in a high-frequency band and components in a low-frequency band.

The filter processing unit 201 may, however, perform component separation into three frequency bands. Specifically, the frequency components included in the reference pixels SP may be subjected to component separation into components in a high-frequency band, components in a medium-frequency band, and components in a low-frequency band. Since the method is similar to that described as a variation of the filter processing unit 201, detailed description thereof will be omitted.

### Inference Unit 202

When the filter processing unit 201 transmits the high-frequency vectors SP_H(VC), the inference unit 202 executes an inference operation by inputting the high-frequency vectors SP_H(VC) to the learned model M as explanatory variables EV. For example, the inference unit 202 reconfigures the learned model M by inputting a parameter updated by the learning instrument 100, and inputs the high-frequency vectors SP_H(VC) of the objective variables EV to the reconfigured model M. Furthermore, the inference unit 202 transmits the model prediction value PV output from the learned model M to the addition unit 203.

Note that, when the filter processing unit 201 separates the medium frequency components SP_M, the inference unit 202 may use the medium frequency vectors SP_M(VC), which are pixel value vectors of the medium frequency components SP_H, as objective variables instead of the high-frequency vectors SP_H(VC).

### Addition Unit 203

The addition unit 203 calculates the intra prediction value PxV, which is a result of performing intra prediction for the pixel value of the pixel X to be predicted, based on the low-frequency components SP_L transmitted by the filter processing unit 201 and the model prediction value PV transmitted by the inference unit 202. For example, the addition unit 203 calculates the intra prediction value PxV of the pixel X to be predicted by performing a restoration operation of adding the low-frequency components SP_L to the model prediction value PV.

Note that, when the filter processing unit 201 separates the medium frequency components SP_M, the addition unit 203 calculates the intra prediction value PxV by adding not only the low-frequency components SP_L but the second frequency components SP_H2 (average value Σm/N) to the model prediction value PV.

### 1-11. Operation Example of Inference Unit 202

Here, the inference unit 202 in FIG. 10 will be described more specifically with reference to FIG. 11. FIG. 11 illustrates an operation example of the inference unit 202.

For example, the inference unit 202 executes inference processing using a model of a multi-layer perceptron (MLP) as a neural network model. Specifically, when the filter processing unit 201 transmits the high-frequency vectors SP_H(VC), the inference unit 202 uses the high-frequency vectors SP_H as explanatory variables, and executes inference processing using the learned model M, which is a model of a learned neural network. For example, the learned model M outputs the model prediction value PV by a forward propagation product-sum operation. As described above, the model prediction value PV is used for the restoration operation performed by the addition unit 203.

### 1-12. Procedure of Preprocessing

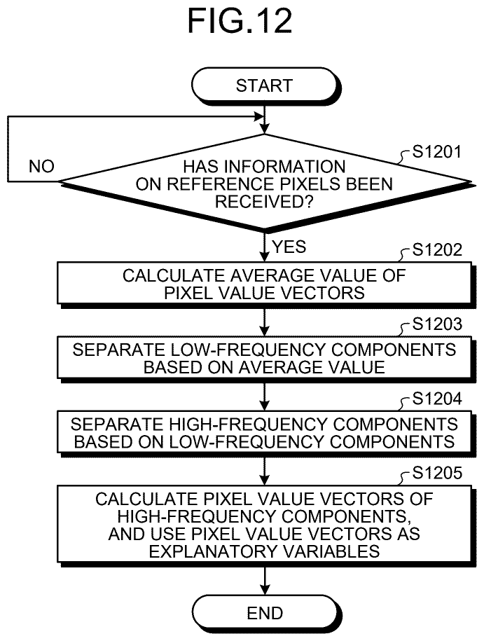

Next, an operation procedure of preprocessing executed by the inference instrument 200 will be described with reference to FIG. 12. FIG. 12 is a flowchart illustrating the operation procedure of preprocessing. The preprocessing here refers to filter processing performed as preprocessing of inference processing using the learned model M. That is, the preprocessing is processing for obtaining an explanatory variable to be input to the learned model M.

First, the filter processing unit 201 determines whether or not information on the reference pixels SP has been received (Step S1201). For example, the filter processing unit 201 determines whether or not the pixel value vectors SP(VC) of N reference pixels SP within the reference range R have been received as information of information on the reference pixels SP. When not receiving the information on the reference pixels SP (Step S1201), the filter processing unit 201 stands by until the information on the reference pixels SP is received.

In contrast, when receiving the information on the reference pixels SP (Step S1201; Yes), the filter processing unit 201 calculates an average value of the pixel value vectors SP(VC) of the reference pixels SP as a representative value representing the pixel value vectors SP(VC) (Step S1202). For example, the filter processing unit 201 calculates the sum Σ of the pixel value vectors SP(VC) of the reference pixels SP. Then, the filter processing unit 201 calculates the average value Σ/N of the pixel value vectors SP(VC) of the N reference pixels SP by dividing the sum Σ by the number N of the reference pixels SP.

Furthermore, the filter processing unit 201 separates the low-frequency components SP_L among frequency components included in the reference pixels SP based on the average value Σ/N (Step S1203). For example, the filter processing unit 201 separates the average value Σ/N as a low-frequency component SP_L among frequency components included in the reference pixels SP. The low-frequency components SP_L are transmitted to the addition unit 203.

Furthermore, the filter processing unit 201 separates the high-frequency components SP_H among frequency components included in the reference pixels SP based on the low-frequency components SP_L (Step S1204). For example, the filter processing unit 201 subtracts the low-frequency components SP_L from frequency components of the N reference pixels SP, and separates the differences obtained by the subtraction as the high-frequency components SP_H of the reference pixels SP.

Furthermore, the addition unit 111 calculates the high-frequency vectors SP_H(VC), which are the pixel value vectors of the high-frequency components SP_H, based on the pixel value vectors SP(VC) of the reference pixels SP and the high-frequency components SP_H of the reference pixels SP, and transmits the high-frequency vectors SP_H(VC) to the inference unit 202 as explanatory variables EV (Step S1205).

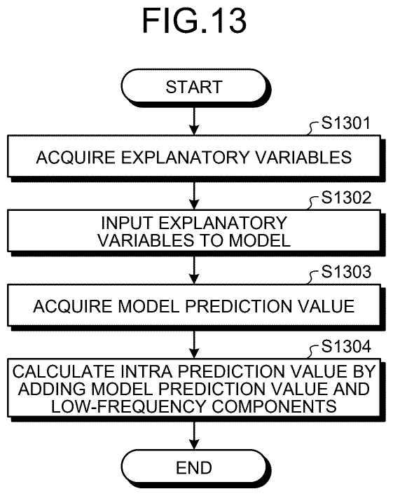

According to the above-described preprocessing, the inference unit 202 can obtain the high-frequency vectors SP_H(VC) of the N reference pixels SP as the explanatory variables EV. In FIG. 13 next, an operation procedure of the inference processing using the explanatory variables EV will be described.

### 1-13. Procedure of Inference Processing

An operation procedure of inference processing executed by the inference instrument 200 will be described with reference to FIG. 13. FIG. 13 is a flowchart illustrating the operation procedure of inference processing.

First, the high-frequency vectors SP_H(VC) of the reference pixels SP are transmitted, the inference unit 202 acquires the high-frequency vectors SP_H(VC) as the explanatory variables EV (Step S1301).

Next, the inference unit 202 inputs the high-frequency vectors SP_H(VC) of the objective variables to the learned model M, which is a model of a neural network (e.g., MLP) and whose parameters have been updated by the learning instrument 100 (Step S1302). As a result, the neural network operates and outputs the model prediction value PV. That is, the inference unit 202 acquires the model prediction value PV (Step S1303).

Next, the addition unit 203 calculates the intra prediction value PxV of the pixel X to be predicted by performing a restoration operation of adding the low-frequency components SP_L to the model prediction value PV (Step S1304).

### 2. Second Embodiment

### 2-1. Configuration Example of Image Encoding Device 300

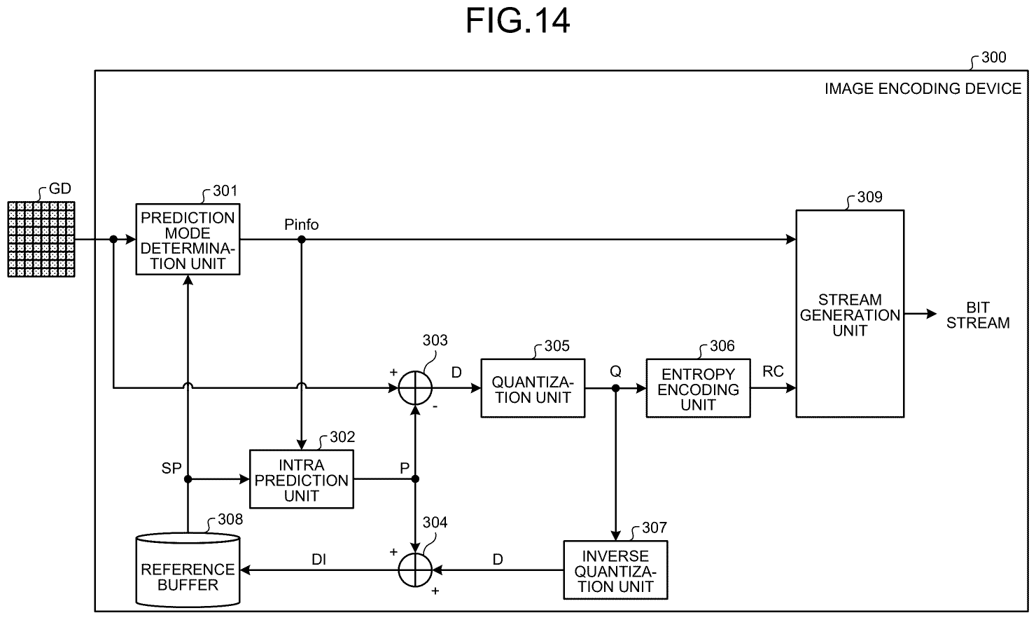

A configuration example of the image encoding device 300 will now be described with reference to FIGS. 14 to 18. Note that FIGS. 14 to 18 mainly illustrate processing units, data flows, and the like. FIGS. 14 to 18 do not necessarily illustrate all. That is, the image encoding device 300 may include a processing unit not illustrated as a block in FIGS. 14 to 18. There may be processing and data flows not illustrated as an arrow and the like in FIGS. 14 to 18.

### 2-2. Overall Configuration Example of Image Encoding Device 300

FIG. 14 is a block diagram illustrating an overall configuration example of the image encoding device 300. The inference instrument 200 described in the first embodiment is mounted on the image encoding device 300. According to an example of FIG. 14, the image encoding device 300 includes a prediction mode determination unit 301, an intra prediction unit 302, a subtraction unit 303, an addition unit 304, a quantization unit 305, an entropy encoding unit 306, an inverse quantization unit 307, a reference buffer 308, and a stream generation unit 309.

### Prediction Mode Determination Unit 301

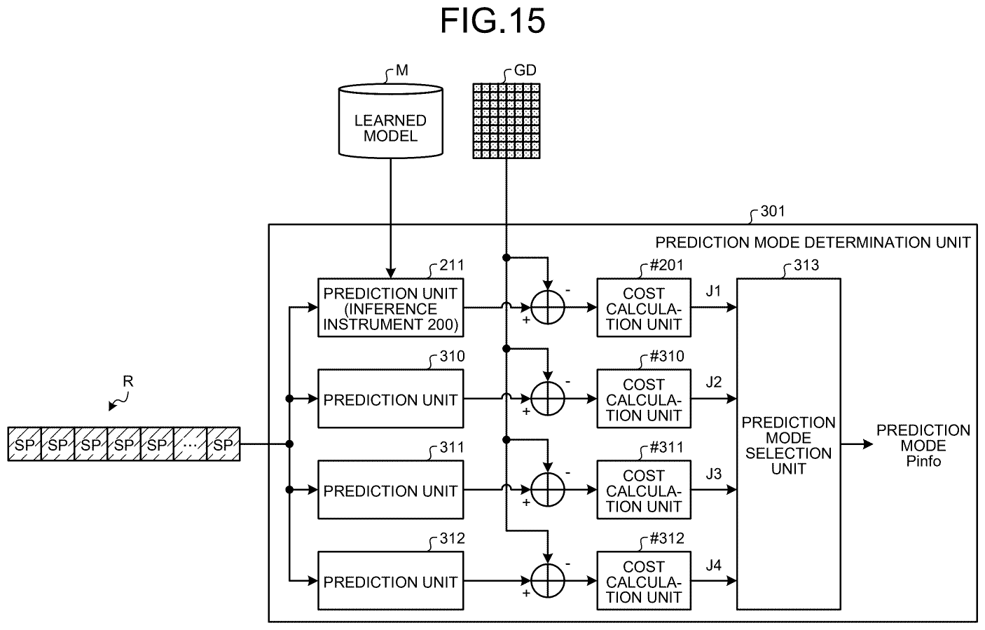

The prediction mode determination unit 301 determines the optimum intra prediction mode with the best encoding efficiency among intra prediction modes (to be described in detail with reference to FIG. 15) of the image encoding device 300 based on cost function values supplied from the intra prediction modes. The prediction mode determination unit 301 performs intra prediction processing on all candidate intra prediction modes by using the reference pixels SP transmitted by the reference buffer 308. Moreover, the prediction mode determination unit 301 calculates cost function values of the intra prediction modes, and determines, as the optimum intra prediction mode, an intra prediction mode with the calculated minimum cost function value, that is, an intra prediction mode with the best encoding efficiency.

Note that, although all intra prediction modes (prediction units) of the image encoding device 300 are processing units that perform intra prediction, the intra prediction modes use different algorithms. Furthermore, the prediction mode determination unit 301 transmits prediction mode information Pinfo to the intra prediction unit 302 and the stream generation unit 309. The prediction mode information Pinfo indicates the determined intra prediction mode.

### Intra Prediction Unit 302

The intra prediction unit 302 performs processing related to generation of a predicted image P in accordance with a prediction mode indicated by the prediction mode information Pinfo. For example, the intra prediction unit 302 calculates intra prediction values of the reference pixels SP by performing the intra prediction processing by using the prediction mode indicated by the prediction mode information Pinfo and the reference pixels SP transmitted by the reference buffer 308. Then, the intra prediction unit 302 generates the predicted image P based on the intra prediction values.

Furthermore, the intra prediction unit 302 transmits the predicted image P to the subtraction unit 303 and the addition unit 304.

### Subtraction Unit 303

The subtraction unit 303 calculates prediction error data D, which is the difference between the original image data GD (input image) and the predicted image P (D=GD−P), and transmits the calculated the prediction error data D to the quantization unit 305.

### Addition Unit 304

The addition unit 304 generates decoded image data DI (locally decoded image) by adding the prediction error data D transmitted by the inverse quantization unit 307 to be described later and the predicted image P. Furthermore, the addition unit 304 accumulates pieces of decoded image data DI in the reference buffer 308.

### Quantization Unit 305

The quantization unit 305 quantizes the prediction error data D, and transmits the quantized data Q to the entropy encoding unit 306 and the inverse quantization unit 307. For example, the quantization unit 305 acquires the quantized data Q by performing processing of directly quantizing luminance value data included in the prediction error data D.

### Entropy Encoding Unit 306

The entropy encoding unit 306 reversibly encodes the quantized data Q, and transmits the reversibly encoded data RC to the stream generation unit 309.

### Inverse Quantization Unit 307

The inverse quantization unit 307 inversely quantizes the quantized data Q. For example, the inverse quantization unit 307 derives the prediction error data D by performing inverse quantization processing on the quantized data Q. That is, the inverse quantization performed by the inverse quantization unit 307 is inverse processing of the quantization performed by the quantization unit 305, and is processing similar to the inverse quantization performed in the image decoding device 400.

Furthermore, the inverse quantization unit 307 transmits the prediction error data D to the addition unit 304.

### Reference Buffer 308

The reference buffer 308 accumulates pieces of decoded image data DI generated by the addition unit 304. For example, the reference buffer 308 may accumulate the pieces of decoded image data DI in a state of being rearranged in an encoding order. Furthermore, the reference buffer 308 may extract the reference pixels SP within the reference range R from the pieces of decoded image data DI, and transmit the extracted reference pixels SP to the prediction mode determination unit 301 and the intra prediction unit 302.

Furthermore, the reference buffer 308 may also accumulate the original image data GD, and transmit the original image data GD to the subtraction unit 303.

### Stream Generation Unit 309

The stream generation unit 309 multiplexes the reversibly encoded data RC (e.g., bit string of syntax elements obtained as a result of encoding) to generate an encoded bit stream. Furthermore, the stream generation unit 309 reversibly encodes the prediction mode information Pinfo, and adds the prediction mode information Pinfo to header information of the encoded bit stream.

### 2-3. Internal Configuration Example of Prediction Mode Determination Unit 301

Next, the prediction mode determination unit 301 in FIG. 14 will be described more specifically with reference to FIG. 15. FIG. 15 is a block diagram illustrating an internal configuration example of the prediction mode determination unit 301. According to an example of FIG. 15, the prediction mode determination unit 301 includes a prediction unit 211, a prediction unit 310, a prediction unit 311, and a prediction unit 312.

Furthermore, according to the example of FIG. 15, the prediction mode determination unit 301 further includes a cost calculation unit #201 corresponding to the prediction unit 211, a cost calculation unit #310 corresponding to the prediction unit 310, a cost calculation unit #311 corresponding to the prediction unit 311, the prediction unit 312, and a cost calculation unit #312 corresponding to a prediction mode selection unit 313.

Here, the prediction unit 211 is a processing unit that operates the inference processing performed by the inference instrument 200 according to the proposed technique of the present disclosure as an intra prediction mode. That is, the prediction unit 211 can be substantially understood as the inference instrument 200. For this reason, the inference instrument 200 corresponding to the prediction unit 211 is mounted on the prediction mode determination unit 301.

In contrast, in the example of FIG. 15, the prediction unit 310, the prediction unit 311, and the prediction unit 312 may be processing units that perform intra prediction processing in any prediction mode.

In the example of FIG. 15, the prediction unit 310 performs intra prediction by using an adjacent left reference algorithm as a prediction mode. The adjacent left reference algorithm is a method in which a prediction value of a pixel adjacent to the left of the pixel X to be predicted is adopted as a prediction value of the pixel X to be predicted.

Furthermore, the prediction unit 311 performs intra prediction by using the LOCO-I algorithm as a prediction mode. The LOCO-I algorithm is a method of calculating a prediction value of the pixel X to be predicted based on a rule-based mathematical model with reference to the pixel adjacent to the left of the pixel X to be predicted, a pixel adjacent to the upper side of the pixel X to be predicted, and a pixel adjacent to the upper left of the pixel X to be predicted.

Furthermore, the prediction unit 312 performs intra prediction by using an oblique direction algorithm as a prediction mode. The oblique direction algorithm is a method of calculating a prediction value of the pixel X to be predicted based on a rule-based mathematical model with reference to a pixel in an oblique direction of the pixel X to be predicted.

### Prediction Unit 211/Cost Calculation Unit #201

When the original image data GD is input, the prediction unit 211 executes a prediction trial in the corresponding intra prediction mode. Specifically, the prediction unit 211 generates a predicted image by applying the inference processing performed by the inference instrument 200 according to the proposed technique of the present disclosure to the reference pixels SP within the reference range R.

The cost calculation unit #201 calculates a cost function value J1 related to the intra prediction processing performed by the prediction unit 211 based on an error between the original image data GD and the predicted image and a cost function. Then, the cost calculation unit #201 transmits the cost function value J1 to the prediction mode selection unit 313.

### Prediction Unit 310/Cost Calculation Unit #310

When the original image data GD is input, the prediction unit 310 executes a prediction trial in the corresponding intra prediction mode. Specifically, the prediction unit 310 generates a predicted image by applying the inference processing using the adjacent left reference algorithm to the reference pixels SP within the reference range R.

The cost calculation unit #310 calculates a cost function value J2 related to the intra prediction processing performed by the prediction unit 310 based on an error between the original image data GD and the predicted image and a cost function. Then, the cost calculation unit #310 transmits the cost function value J2 to the prediction mode selection unit 313.

### Prediction Unit 311/Cost Calculation Unit #311

When the original image data GD is input, the prediction unit 311 executes a prediction trial in the corresponding intra prediction mode. Specifically, the prediction unit 311 generates a predicted image by applying the inference processing using the LOCO-I algorithm to the reference pixels SP within the reference range R.

The cost calculation unit #311 calculates a cost function value J3 related to the intra prediction processing performed by the prediction unit 311 based on an error between the original image data GD and the predicted image and a cost function. Then, the cost calculation unit #311 transmits the cost function value J3 to the prediction mode selection unit 313.

### Prediction Unit 312/Cost Calculation Unit #312

When the original image data GD is input, the prediction unit 312 executes a prediction trial in the corresponding intra prediction mode. Specifically, the prediction unit 312 generates a predicted image by applying the inference processing using the oblique direction algorithm to the reference pixels SP within the reference range R.

The cost calculation unit #312 calculates a cost function value J4 related to the intra prediction processing performed by the prediction unit 312 based on an error between the original image data GD and the predicted image and a cost function. Then, the cost calculation unit #312 transmits the cost function value J4 to the prediction mode selection unit 313.

### Prediction Mode Selection Unit 313

The prediction mode selection unit 313 selects the optimum intra prediction mode with the best encoding efficiency from all candidate intra prediction modes. According to the example of FIG. 15, the prediction mode selection unit 313 selects the optimum intra prediction mode with the best encoding efficiency from four types of intra prediction modes, that is, a prediction mode corresponding to the prediction unit 211, a prediction mode corresponding to the prediction unit 310, a prediction mode corresponding to the prediction unit 311, and a prediction mode corresponding to the prediction unit 312.

Specifically, the prediction mode selection unit 313 may compare the cost function value J1, the cost function value J2, the cost function value J3, and the cost function value J4, and select a prediction mode with the lowest value as the optimum intra prediction mode with the best encoding efficiency. Then, the prediction mode selection unit 313 transmits the prediction mode information Pinfo indicating the selected intra prediction mode to the intra prediction unit 302 and the stream generation unit 309.

Note that, although FIG. 15 illustrates, as candidate intra prediction modes, four types of intra prediction modes, that is, the inference processing according to the proposed technique of the present disclosure, the adjacent left reference algorithm, the LOCO-I algorithm, and the oblique direction algorithm, the prediction mode is not limited to the four types. For example, the prediction mode determination unit 301 may include only the prediction unit 211 including the inference instrument 200 according to the proposed technique of the present disclosure. Furthermore, the prediction mode determination unit 301 may include a prediction unit corresponding to an algorithm other than the adjacent left reference algorithm, the LOCO-I algorithm, and the oblique direction algorithm.

Furthermore, the prediction mode determination unit 301 may select an intra prediction mode based on calculation amounts of the prediction unit 211, the prediction unit 310, the prediction unit 311, and the prediction unit 312. For example, the cost calculation unit #201 calculates a calculation amount of the prediction unit 211. The cost calculation unit #310 calculates a calculation amount of the prediction unit 310. The cost calculation unit #311 calculates a calculation amount of the prediction unit 311. The cost calculation unit #312 calculates a calculation amount of the prediction unit 312. Then, the prediction mode selection unit 313 may compare the calculation amounts to select a prediction mode with the lowest value as the optimum intra prediction mode.

### 2-4. Variation of Prediction Mode Determination Unit 301

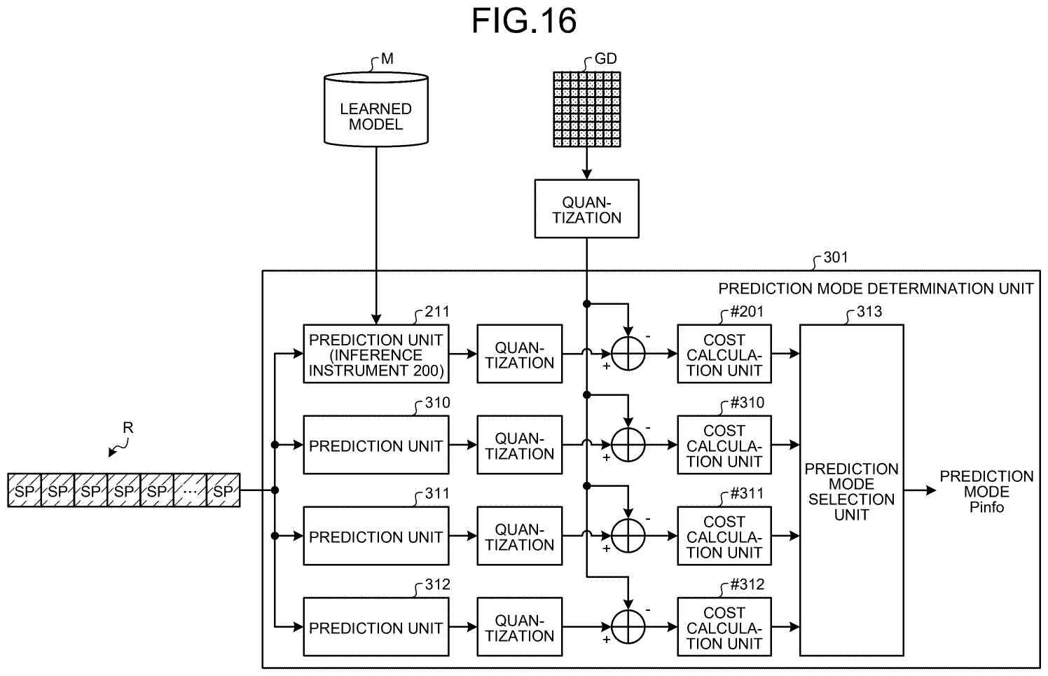

FIG. 15 illustrates a typical operation example of the prediction mode determination unit 301. The prediction mode determination unit 301 may, however, determine the intra prediction mode by a method different from that in the example of FIG. 15. For example, the prediction mode determination unit 301 may determine the optimum intra prediction mode with the best encoding efficiency among the intra prediction modes based on a rate distortion (RD) cost. FIG. 16 illustrates the processing as a variation of the prediction mode determination unit 301. FIG. 16 is a block diagram illustrating a variation of the prediction mode determination unit 301. Note that an internal configuration example of the prediction mode determination unit 301 according to the variation may be similar to that in the example of FIG. 15, and description thereof will be omitted.

In the variation, a difference image is quantized and variable-length encoding is performed for candidate intra prediction modes. Then, a bit rate and encoding distortion are calculated for each of the intra prediction modes. In this regard, processing units of the prediction mode determination unit 301 operate as follows.

### Prediction Unit 211/Cost Calculation Unit #201

When the original image data GD is input, the prediction unit 211 executes a prediction trial in the corresponding intra prediction mode. Specifically, the prediction unit 211 generates a predicted image by applying the inference processing performed by the inference instrument 200 according to the proposed technique of the present disclosure to the reference pixels SP within the reference range R.

The cost calculation unit #201 calculates a bit rate Rate to be used when an error between the original image data GD and the predicted image P and prediction mode information are encoded, and calculates encoding distortion D. Then, the cost calculation unit #201 calculates an RD cost C1 based on a Lagrange multiplier λ calculated in accordance with a quantization parameter selected at the time of encoding, the bit rate Rate, and a Lagrange cost function defined by the encoding distortion D.

### Prediction Unit 310/Cost Calculation Unit #310

When the original image data GD is input, the prediction unit 310 executes a prediction trial in the corresponding intra prediction mode. Specifically, the prediction unit 310 generates a predicted image by applying the inference processing using the adjacent left reference algorithm to the reference pixels SP within the reference range R.

The cost calculation unit #310 calculates the bit rate Rate to be used when an error between the original image data GD and the predicted image and prediction mode information are encoded, and calculates the encoding distortion D. Then, the cost calculation unit #310 calculates an RD cost C2 based on the Lagrange multiplier λ, the bit rate Rate, and the Lagrange cost function defined by the encoding distortion D.

### Prediction Unit 311/Cost Calculation Unit #311

When the original image data GD is input, the prediction unit 311 executes a prediction trial in the corresponding intra prediction mode. Specifically, the prediction unit 311 generates a predicted image by applying the inference processing using the LOCO-I algorithm to the reference pixels SP within the reference range R.

The cost calculation unit #311 calculates the bit rate Rate to be used when an error between the original image data GD and the predicted image and prediction mode information are encoded, and calculates the encoding distortion D. Then, the cost calculation unit #311 calculates an RD cost C3 based on the Lagrange multiplier λ, the bit rate Rate, and the Lagrange cost function defined by the encoding distortion D.

### Prediction Unit 312/Cost Calculation Unit #312

When the original image data GD is input, the prediction unit 312 executes a prediction trial in the corresponding intra prediction mode. Specifically, the prediction unit 312 generates a predicted image by applying the inference processing using the oblique direction algorithm to the reference pixels SP within the reference range R.

The cost calculation unit #312 calculates the bit rate Rate to be used when an error between the original image data GD and the predicted image and prediction mode information are encoded, and calculates the encoding distortion D. Then, the cost calculation unit #312 calculates an RD cost C4 based on the Lagrange multiplier λ, the bit rate Rate, and the Lagrange cost function defined by the encoding distortion D.

### Prediction Mode Selection Unit 313

The prediction mode selection unit 313 may compare the RD cost C1, the RD cost C2, the RD cost C3, and the RD cost C4, and select a prediction mode with the lowest value as the optimum intra prediction mode with the best encoding efficiency. Then, the prediction mode selection unit 313 transmits the prediction mode information Pinfo indicating the selected intra prediction mode to the intra prediction unit 302 and the stream generation unit 309.

### 2-5. Internal Configuration Example of Intra Prediction Unit 302

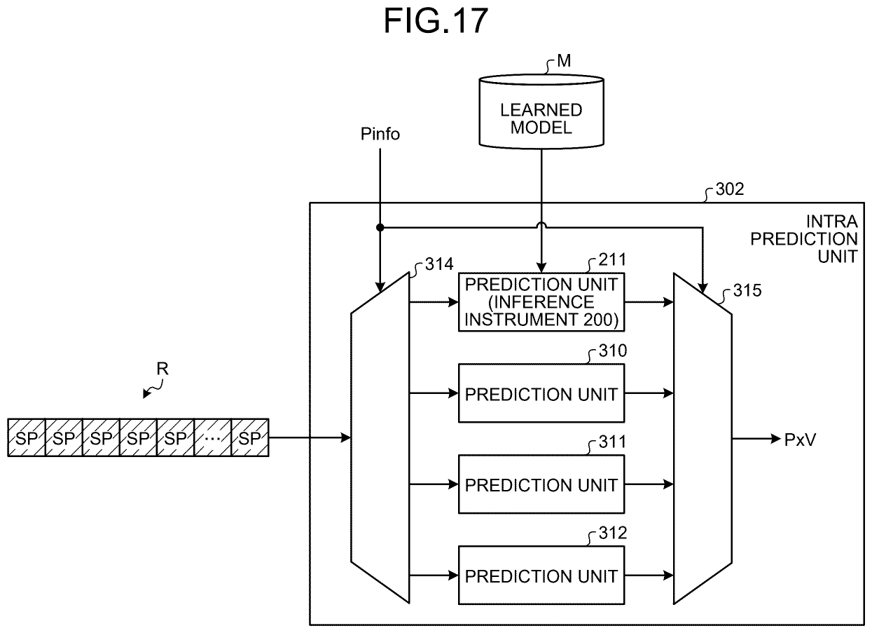

Next, the intra prediction unit 302 in FIG. 14 will be described more specifically with reference to FIG. 17. FIG. 17 is a block diagram illustrating an internal configuration example of the intra prediction unit 302. An example of FIG. 17 corresponds to that of FIG. 15 (also to that of FIG. 16). Thus, the intra prediction unit 302 includes a prediction unit similar to that of the prediction mode determination unit 301. That is, the intra prediction unit 302 can operate in four types of prediction modes similar to those of the prediction mode determination unit 301. Specifically, as illustrated in FIG. 17, the intra prediction unit 302 includes the prediction unit 211, the prediction unit 310, the prediction unit 311, and the prediction unit 312. Furthermore, the intra prediction unit 302 further includes a multiplexer 314 and a multiplexer 315.

First, when the original image data GD is input, the intra prediction unit 302 executes intra prediction in a prediction mode determined by the prediction mode determination unit 301, and outputs an intra prediction value.

### Multiplexer 314

When the reference pixels SP within the reference range R are input in the original image data GD, the multiplexer 314 identifies a prediction mode designated by the prediction mode information Pinfo based on the prediction mode information Pinfo transmitted by the prediction mode determination unit 301. Then, the multiplexer 314 causes an intra prediction unit corresponding to the identified prediction mode among the prediction unit 211, the prediction unit 310, the prediction unit 311, and the prediction unit 312 to execute intra prediction processing in accordance with the prediction mode. For example, the multiplexer 314 causes the intra prediction unit corresponding to the identified prediction mode to execute the intra prediction processing by transmitting the reference pixels SP.

For example, when the inference processing according to the proposed technique of the present disclosure is designated by the prediction mode information Pinfo, the multiplexer 314 transmits the reference pixels SP to the prediction unit 211 (inference instrument 200). As a result, the prediction unit 211 executes the intra prediction processing using the learned model M. The operation content of the prediction unit 211 is as described for the inference instrument 200 in FIGS. 10 to 13, for example. Furthermore, the prediction value calculated in the intra prediction processing is transmitted to the multiplexer 315.

### Multiplexer 315

When receiving the prediction value, the multiplexer 315 outputs the received prediction value as an intra prediction value.

### 2-6. Procedure of Image Encoding Processing

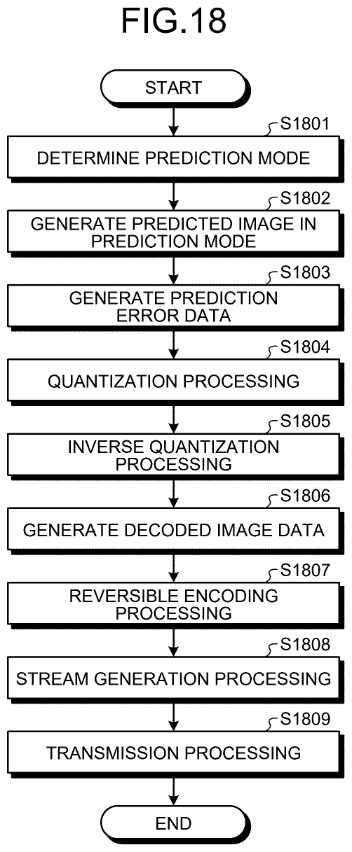

Image encoding processing executed by the image encoding device 300 will be described with reference to FIG. 18. FIG. 18 is a flowchart illustrating an operation procedure of the image encoding processing.

First, the prediction mode determination unit 301 determines an intra prediction mode to be used for generating a predicted image from among candidate intra prediction modes (Step S1801). In the processing, pieces of prediction processing are performed in all candidate intra prediction modes. Cost function values in all the candidate prediction modes are calculated. Then, the optimum intra prediction mode is determined based on the calculated cost function values. The prediction mode information Pinfo indicating the optimum intra prediction mode is transmitted to the intra prediction unit 302 and the stream generation unit 309.

Note that the prediction mode determination unit 301 may check whether there is a locally decoded image with reference to the reference buffer 308, and determine the intra prediction mode based on the check result. For example, when a locally decoded image is not accumulated in the reference buffer 308, the prediction mode determination unit 301 may determine any predetermined intra prediction mode as an initial mode to be used for generating a predicted image. In contrast, when a locally decoded image is accumulated in the reference buffer 308, the prediction mode determination unit 301 may determine the optimum intra prediction mode based on the cost function values as described above.

The intra prediction unit 302 performs processing related to generation of the predicted image P in accordance with a prediction mode indicated by the prediction mode information Pinfo (Step S1802). For example, the intra prediction unit 302 calculates intra prediction values of the reference pixels SP by performing the intra prediction processing by using the prediction mode indicated by the prediction mode information Pinfo and the reference pixels SP transmitted by the reference buffer 308. Then, the intra prediction unit 302 generates the predicted image P based on the intra prediction values. The predicted image P is transmitted to the subtraction unit 303 and the addition unit 304.

The subtraction unit 303 calculates the prediction error data D (Step S1803). For example, the subtraction unit 303 calculates the prediction error data D, which is the difference between the predicted image P generated by the intra prediction unit 302 and the original image data GD. The prediction error data D is transmitted to the quantization unit 305.

The quantization unit 305 performs quantization processing (Step S1804). For example, the quantization unit 305 acquires the quantized data Q as a quantized value by performing processing of directly quantizing luminance value data included in the prediction error data D. For example, the quantization unit 305 may divide the prediction error data D, truncate lower-level quantized data Q out of quantized values obtained by quantizing pieces of the divided prediction error data D, and transmit upper-level quantized data Q to the entropy encoding unit 306 and the inverse quantization unit 307.

The inverse quantization unit 307 performs inverse quantization processing (Step S1805). The quantized data Q is returned to the value before the quantization performed by the quantization unit 305, that is, the prediction error data D by the inverse quantization processing. That is, the inverse quantization unit 307 restores the prediction error data D by performing inverse quantization processing on the quantized data Q. Furthermore, the restored prediction error data D is transmitted to the addition unit 304.

The addition unit 304 generates the decoded image data DI (Step S1806). For example, the addition unit 304 adds the prediction error data D and the predicted image P generated by the intra prediction unit 302 to generate the decoded image data DI (locally decoded image). Pieces of decoded image data DI are accumulated in the reference buffer 308.

The entropy encoding unit 306 performs reversible encoding processing (Step S1807). Specifically, the entropy encoding unit 306 reversibly encodes the quantized data Q. That is, reversible encoding such as variable-length encoding and arithmetic encoding is performed on the quantized data Q to compress data. The reversibly encoded data RC is transmitted to the stream generation unit 309.

The stream generation unit 309 performs stream generation processing (Step S1808). For example, the stream generation unit 309 multiplexes the reversibly encoded data RC to generate an encoded bit stream. Furthermore, the stream generation unit 309 reversibly encodes the prediction mode information Pinfo, and adds the prediction mode information Pinfo to header information of the encoded bit stream.

The reference buffer 308 performs transmission based on the pieces of decoded image data DI (Step S1809). For example, when pieces of decoded image data DI are accumulated, the reference buffer 308 extracts the reference pixels SP within the reference range R from the decoded image data DI, and transmits the extracted reference pixels SP to the prediction mode determination unit 301 and the intra prediction unit 302.

### 2-7. Configuration Example of Image Decoding Device 400

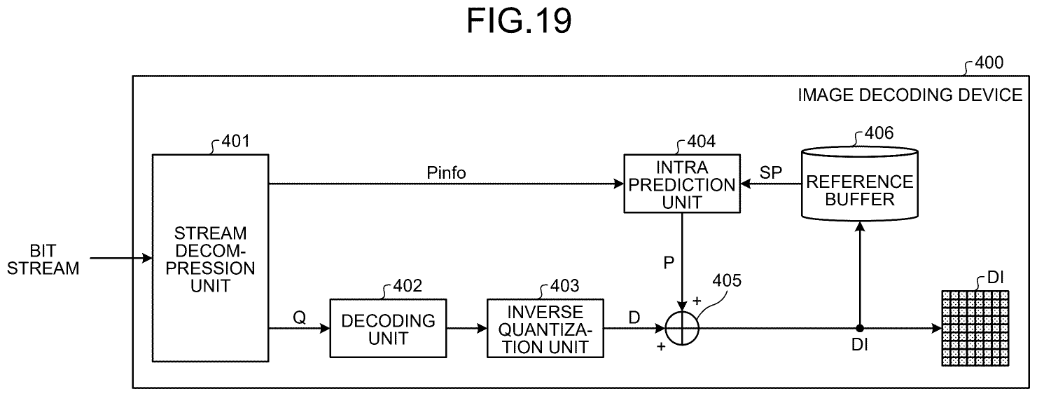

A configuration example of the image decoding device 400 will now be described with reference to FIG. 19. Note that FIG. 19 mainly illustrates processing units, data flows, and the like. FIG. 19 does not necessarily illustrate all. That is, the image decoding device 400 may include a processing unit not illustrated as a block in FIG. 19. There may be processing and data flows not illustrated as an arrow and the like in FIG. 19.

### 2-8. Overall Configuration Example of Image Decoding Device 400

FIG. 19 is a block diagram illustrating an overall configuration example of the image decoding device 400. The inference instrument 200 described in the first embodiment is mounted on the image decoding device 400. According to an example of FIG. 19, the image decoding device 400 includes a stream decompression unit 401, a decoding unit 402, an inverse quantization unit 403, an intra prediction unit 404, an addition unit 405, and a reference buffer 406.

### Stream Decompression Unit 401

The stream decompression unit 401 uses an encoded bit stream as input, and separates encoded information by a method corresponding to an encoding method of the entropy encoding unit 306 of the image encoding device 300. For example, the stream decompression unit 401 derives parameters by performing variable-length decoding on the reversibly encoded data RC from a bit string of the encoded bit stream. The parameters include the header information, the prediction mode information Pinfo, and the quantized data Q.

Therefore, the stream decompression unit 401 transmits the prediction mode information Pinfo to the intra prediction unit 404, and transmits the quantized data Q to the decoding unit 402.

### Decoding Unit 402

The decoding unit 402 decodes the quantized data Q by a method corresponding to the encoding method of the entropy encoding unit 306.

### Inverse Quantization Unit 403

The inverse quantization unit 403 inversely quantizes the quantized data Q decoded by the decoding unit 402 by a method corresponding to a quantizing method of the quantization unit 305 of the image encoding device 300. As a result, the prediction error data D is obtained. Therefore, the inverse quantization unit 403 transmits the prediction error data D to the addition unit 405.

### Intra Prediction Unit 404

The intra prediction unit 404 performs processing related to generation of the predicted image P in accordance with a prediction mode indicated by the prediction mode information Pinfo transmitted by the stream decompression unit 401. For example, the intra prediction unit 404 calculates intra prediction values of the reference pixels SP by performing the intra prediction processing by using the prediction mode indicated by the prediction mode information Pinfo and the reference pixels SP transmitted by the reference buffer 406. Then, the intra prediction unit 302 generates the predicted image P based on the intra prediction values. Furthermore, the intra prediction unit 404 transmits the predicted image P to the addition unit 405.

Here, the intra prediction unit 404 has the same configuration as the above-described intra prediction unit 302. Specifically, an internal configuration example of the intra prediction unit 404 may be the same as that of the intra prediction unit 302. That is, the internal configuration example of the intra prediction unit 404 may be the same as that in FIG. 17. According to the example of FIG. 17, the intra prediction unit 404 includes the prediction unit 211, the prediction unit 310, the prediction unit 311, and the prediction unit 312, and further includes the multiplexer 314 and the multiplexer 315.

Thus, for example, when the inference processing according to the proposed technique of the present disclosure is designated by the prediction mode information Pinfo, the reference pixels SP are transmitted to the prediction unit 211 (inference instrument 200), and then the prediction unit 211 executes the intra prediction processing using the learned model M.

### Addition Unit 405

The addition unit 405 generates the decoded image data DI (locally decoded image) by adding the prediction error data D and the predicted image P. Furthermore, the addition unit 405 accumulates pieces of decoded image data DI in the reference buffer 406.

### Reference Buffer 406

The reference buffer 406 accumulates the pieces of decoded image data DI generated by the addition unit 405. For example, the reference buffer 406 may accumulate the pieces of decoded image data DI in a state of being rearranged in an encoding order. Furthermore, the reference buffer 406 may extract the reference pixels SP within the reference range R from the pieces of decoded image data DI, and transmit the extracted reference pixels SP to the intra prediction unit 404.

Furthermore, the pieces of decoded image data DI may be rearranged from in a decoding order to in a reproduction order. A group of the rearranged pieces of decoded image data DI may be output to the outside of the image decoding device 400 as moving image data.

### 2-9. Procedure of Image Decoding Processing

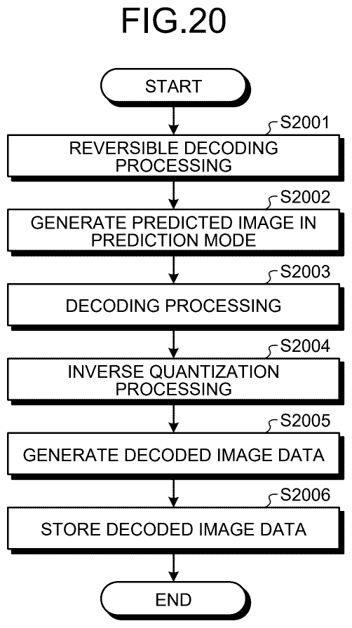

Image decoding processing executed by the image decoding device 400 will be described with reference to FIG. 20. FIG. 20 is a flowchart illustrating an operation procedure of the image decoding processing.

When an encoded bit stream is input, the stream decompression unit 401 performs reversible decoding processing (Step S2001). The stream decompression unit 401 decodes the encoded bit stream. The quantized data Q encoded by the entropy encoding unit 306 is obtained by the processing, and transmitted to the decoding unit 402. Furthermore, the stream decompression unit 401 reversibly decodes prediction mode information in the header information of the encoded bit stream, and transmits the obtained prediction mode information Pinfo to the intra prediction unit 404.

The intra prediction unit 404 performs processing related to generation of the predicted image P in accordance with a prediction mode indicated by the prediction mode information Pinfo (Step S2002). For example, the intra prediction unit 404 calculates intra prediction values of the reference pixels SP by performing the intra prediction processing by using the prediction mode indicated by the prediction mode information Pinfo and the reference pixels SP transmitted by the reference buffer 406. Then, the intra prediction unit 404 generates the predicted image P based on the intra prediction values. The predicted image P is transmitted to the addition unit 405.

The decoding unit 402 performs decoding processing (Step S2003). Specifically, the decoding unit 402 decodes the quantized data Q. The decoded quantized data Q is transmitted to the inverse quantization unit 403.

The inverse quantization unit 403 performs inverse quantization processing (Step S2004). Specifically, the inverse quantization unit 403 inversely quantizes the quantized data Q decoded by the decoding unit 402 with characteristics corresponding to the characteristics of the quantization unit 305 of the image encoding device 300. The quantized data Q is returned to the value before the quantization, that is, the prediction error data D by the inverse quantization processing. That is, the inverse quantization unit 403 restores the prediction error data D by performing inverse quantization processing on the quantized data Q. The restored prediction error data D is transmitted to the addition unit 405.

The addition unit 405 generates the decoded image data DI (Step S2005). For example, the addition unit 405 adds the prediction error data D and the predicted image P generated by the intra prediction unit 404 to generate the decoded image data DI (locally decoded image). This decodes an original image. Pieces of decoded image data DI are accumulated in the reference buffer 308.

Furthermore, the reference buffer 406 stores pieces of decoded image data DI (Step S2006).

### 3. Variations According to First Embodiment

### 3-1. Outline of Variations

The learning processing performed by the learning instrument 100 and the inference processing performed by the inference instrument 200 are not limited to those in the example described above in the first embodiment. Therefore, in the following description, variations of the learning processing performed by the learning instrument 100 and the inference processing performed by the inference instrument 200 will be described.

### 3-2. Variation (1) of Filter Processing Performed by Learning Instrument 100

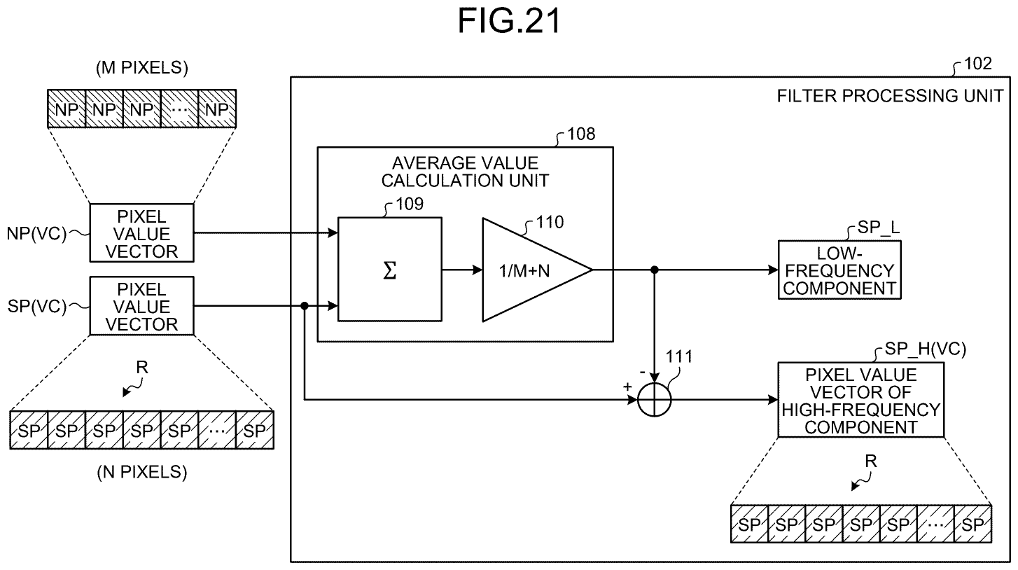

In the first embodiment, an example has been described in which the filter processing unit 102 performs component separation based on the pixel value vectors SP(VC) of the reference pixels SP (i.e., N reference pixels) within the reference range R. The filter processing unit 102 may, however, perform component separation by further using pixel value vectors NP(VC) of out-of-range pixels NP, which are pixels outside the reference range R not included in the reference range R. This point will be described with reference to FIG. 21. FIG. 21 is a block diagram illustrating an internal configuration example (1) of the filter processing unit 102 according to a variation of the first embodiment.

According to an example of FIG. 21, the representative value calculation unit 108 extracts predetermined M pixels from the out-of-range pixels NP, which are pixels outside the reference range R, and inputs the extracted M out-of-range pixels NP to the summing unit 109. Note that the pixel scan unit 101 may perform the processing of extracting the M out-of-range pixels NP.

In the first embodiment, the summing unit 109 calculates the sum Σ by adding the pixel value vectors SP(VC) of the N reference pixels SP. In a variation (1), however, the summing unit 109 calculates the sum Σ by adding the pixel value vectors SP(VC) of the N reference pixels SP and the pixel value vectors SP(VC) of the M out-of-range pixels NP.

Then, the division unit 110 calculates an average value Σ/N+M by dividing the sum Σ calculated by the summing unit 109 by the number N+M of all pixels. Here, the division unit 110 determines the average value Σ/N+M as an average value of the pixel value vectors SP(VC) of the N reference pixels SP. That is, the division unit 110 separates the average value Σ/N+M as a low-frequency component SP_L among frequency components included in the reference pixels SP.

The addition unit 111 separates the high-frequency components SP_H from the N reference pixels SP by executing filter processing on the pixel value vectors SP(VC) of the reference pixels SP. In the filter processing, the low-frequency components SP_L (average value Σ/N+M) are applied as filter information.

For example, the addition unit 111 may subtract the low-frequency components SP_L from frequency components of N reference pixels SP, and separate the differences obtained by the subtraction as the high-frequency components SP_H of the reference pixels SP. Furthermore, the addition unit 111 calculates the high-frequency vectors SP_H(VC), which are the pixel value vectors of the high-frequency components SP_H, based on the pixel value vectors SP(VC) of the reference pixels SP on which the separation has been executed and the high-frequency components SP_H of the reference pixels SP, and transmits the high-frequency vectors SP_H(VC) to the learning unit 104 as explanatory variables. In contrast, the pixel value vectors NP(VC) of the out-of-range pixels NP are not transmitted.

### 3-3. Variation (2) of Filter Processing Performed by Learning Instrument 100

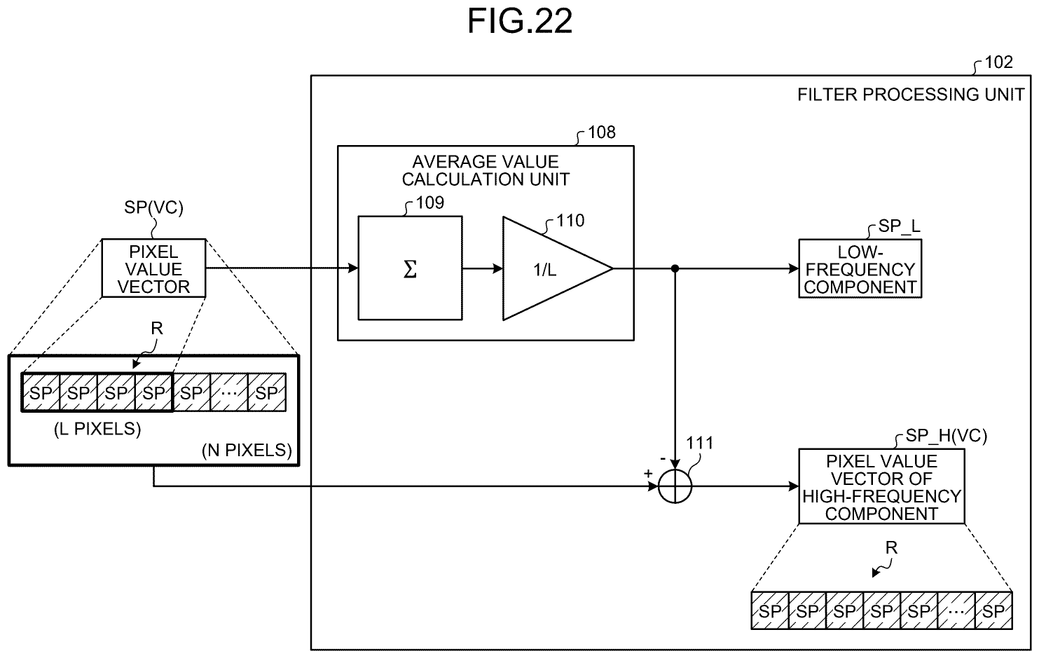

Furthermore, the filter processing unit 102 may perform component separation by using only L reference pixels SP among reference pixels SP (i.e., N reference pixels) within the reference range R. This point will be described with reference to FIG. 22. FIG. 22 is a block diagram illustrating an internal configuration example (2) of the filter processing unit 102 according to a variation of the first embodiment.

According to an example of FIG. 22, the representative value calculation unit 108 extracts predetermined L pixels from the N reference pixels SP within the reference range R, and inputs the extracted L reference pixels SP to the summing unit 109. Note that the pixel scan unit 101 may perform the processing of extracting the L reference pixels SP.

In the first embodiment, the summing unit 109 calculates the sum Σ by adding the pixel value vectors SP(VC) of the N reference pixels SP. In a variation (2), however, the summing unit 109 calculates the sum Σ by adding the pixel value vectors SP(VC) of the L reference pixels SP.

Then, the division unit 110 calculates an average value Σ/L by dividing the sum Σ calculated by the summing unit 109 by the number L of pixels. Here, the division unit 110 determines the average value Σ/L as an average value of the pixel value vectors SP(VC) of the N reference pixels SP. That is, the division unit 110 separates the average value Σ/L as a low-frequency component SP_L among frequency components included in the reference pixels SP.

The addition unit 111 separates the high-frequency components SP_H from the N reference pixels SP by executing filter processing on the pixel value vectors SP(VC) of the reference pixels SP. In the filter processing, the low-frequency components SP_L (average value Σ/L) are applied as filter information.

For example, the addition unit 111 may subtract the low-frequency components SP_L from frequency components of N reference pixels SP, and separate the differences obtained by the subtraction as the high-frequency components SP_H of the reference pixels SP. Furthermore, the addition unit 111 calculates the high-frequency vectors SP_H(VC), which are the pixel value vectors of the high-frequency components SP_H, based on the pixel value vectors SP(VC) of the reference pixels SP on which the separation has been executed and the high-frequency components SP_H of the reference pixels SP, and transmits the high-frequency vectors SP_H(VC) to the learning unit 104 as explanatory variables EV.

### 3-4. Feature Amounts Used in Learning Processing and Inference Processing

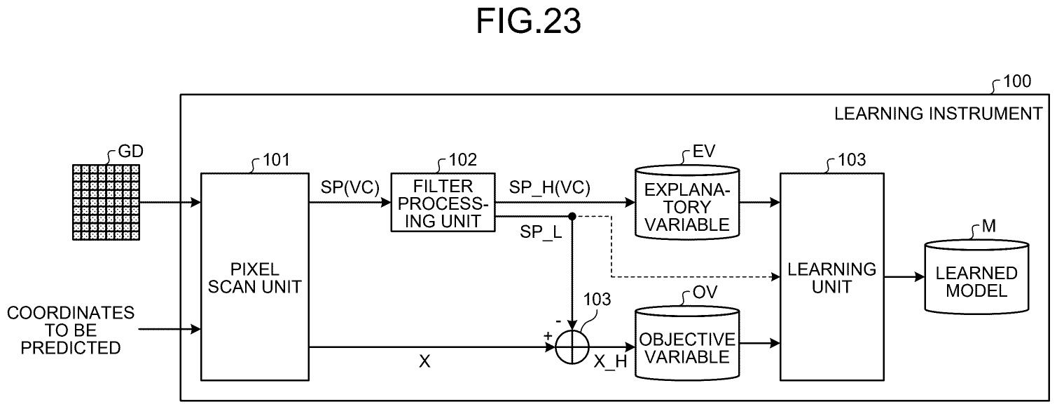

In the first embodiment, an example has been described with reference to FIG. 3 and the like. In the example, the filter processing unit 102 separates the high-frequency components SP_H and the low-frequency components SP_L from frequency components included in the reference pixels SP by using filter information calculated from the pixel value vectors SP(VC), and transmits the high-frequency vectors SP_H(VC) to the learning unit 104. Furthermore, as a result, an example has been described in which the high-frequency vectors SP_H(VC) are used as the explanatory variables EV in the learning processing performed by the learning unit 104. Feature amounts used as the explanatory variables EV are, however, not limited to the high-frequency vectors SP_H(VC). For example, the low-frequency components SP_L (example of feature amounts) separated by the filter processing unit 102 may also be used as the explanatory variables EV. This point will be described with reference to FIG. 23. FIG. 23 is a block diagram illustrating an overall configuration example of the learning instrument 100 according to the variation of the first embodiment.

For example, in the example of FIG. 3, the filter processing unit 102 only transmits the low-frequency components SP_L separated from frequency components included in the reference pixels SP to the difference calculation unit 103. As illustrated in FIG. 23, however, in the variation, the filter processing unit 102 may transmit the low-frequency components SP_L separated from the frequency components included in the reference pixels SP also to the learning unit 104. Furthermore, in the example, the learning unit 104 couples the low-frequency components SP_L with the high-frequency component X_H transmitted from the filter processing unit 102 as an explanatory variable EV. That is, the learning unit 104 executes the learning processing related to a neural network model based on learning data in which a feature amount obtained by combining the high-frequency component X_H with the low-frequency components SP_L is used as an explanatory variable EV.

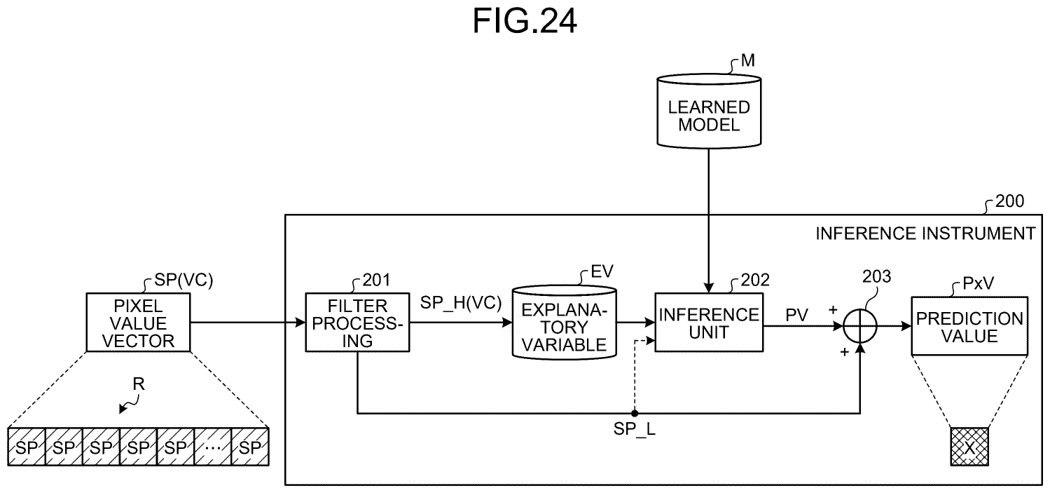

Furthermore, as in the above-described example, when the low-frequency components SP_L are also used as the explanatory variables EV, the low-frequency components SP_L needs to be used as the explanatory variables EV also in the inference processing. This point will be described with reference to FIG. 24. FIG. 24 is a block diagram illustrating an overall configuration example of the inference instrument 200 according to the variation of the first embodiment.

For example, in the example of FIG. 10, the filter processing unit 201 only transmits the low-frequency components SP_L separated from frequency components included in the reference pixels SP to the addition unit 203. As illustrated in FIG. 24, however, in the variation, the filter processing unit 201 may transmit the low-frequency components SP_L separated from the frequency components included in the reference pixels SP also to the inference unit 202. Furthermore, in the example, the inference unit 202 couples the low-frequency components SP_L with the high-frequency component X_H transmitted from the filter processing unit 102 as an explanatory variable EV. That is, the inference unit 202 executes an inference operation by inputting a feature amount obtained by combining the high-frequency component X_H with the low-frequency components SP_L to the learned model M as an explanatory variable EV.

### 3-5. Information Processing Accompanying Quantization

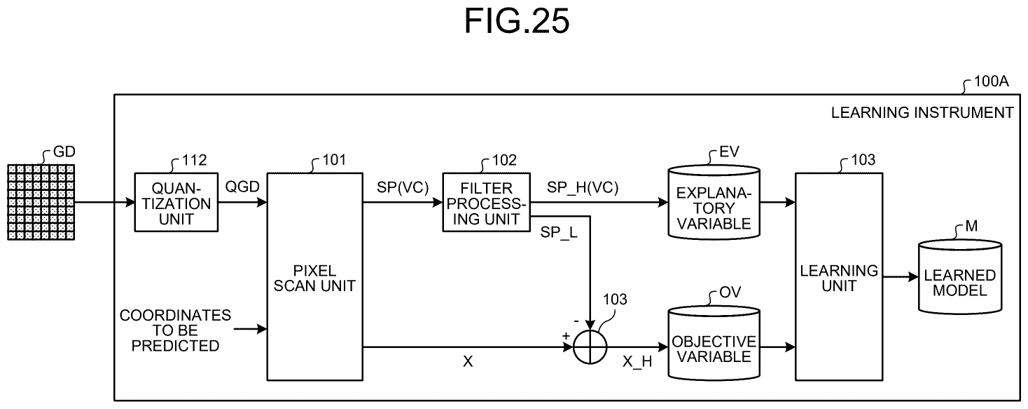

In the first embodiment, an example has been described in which the pixel scan unit 101 uses the original image data GD itself as an input image and extracts the pixel X to be predicted and the reference pixels SP from the input image. The pixel scan unit 101 may, however, extract the pixel X to be predicted and the reference pixels SP by using, as an input image, quantized data QD obtained by quantizing pixels constituting the original image data GD. This point will be described with reference to FIG. 25. FIG. 25 is a block diagram illustrating an overall configuration example of the learning instrument 100 according to the variation of the first embodiment.

FIG. 25 illustrates a learning instrument 100A in an example of the learning instrument 100 according to the variation. The learning instrument 100 further includes a quantization unit 112 as compared with the learning instrument 100 in FIG. 3.

### Quantization Unit 112

When the original image data GD is input, the quantization unit 112 generates image data QGD by performing quantization processing on pixels constituting the input original image data GD. Furthermore, the quantization unit 112 transmits the generated image data QGD to the pixel scan unit 101.

In this case, the pixel scan unit 101 extracts, as the pixel X to be predicted, one pixel at a position defined by the coordinates to be predicted in the image data QGD. Furthermore, the pixel scan unit 101 determines the reference range R in the image data QGD based on the coordinates to be predicted, and extracts pixels within the determined reference range R as the reference pixels SP. The pixel values are quantized in the reference pixels SP.

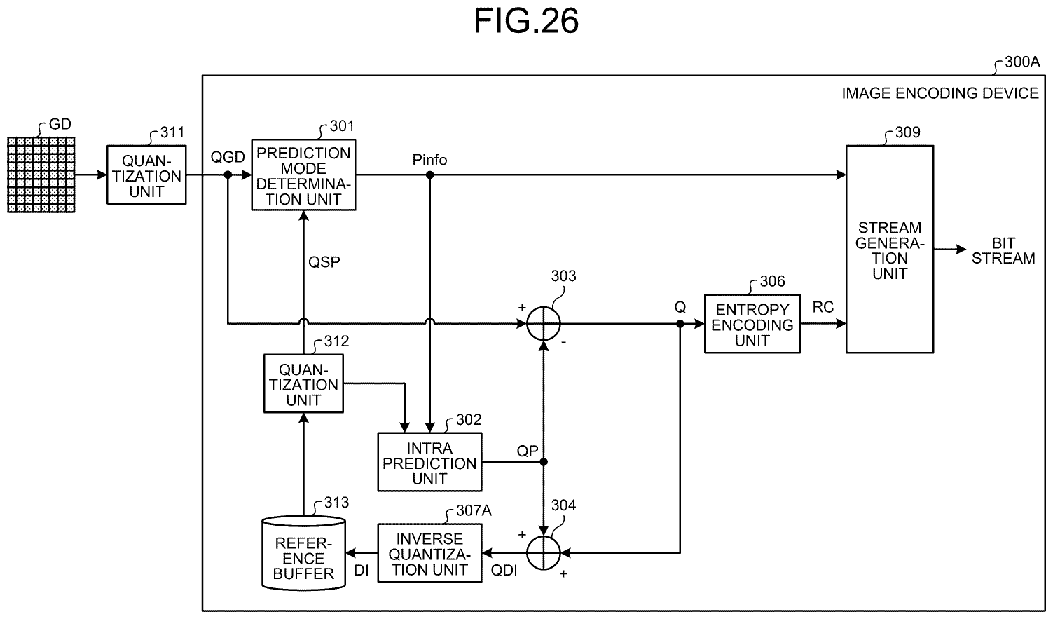

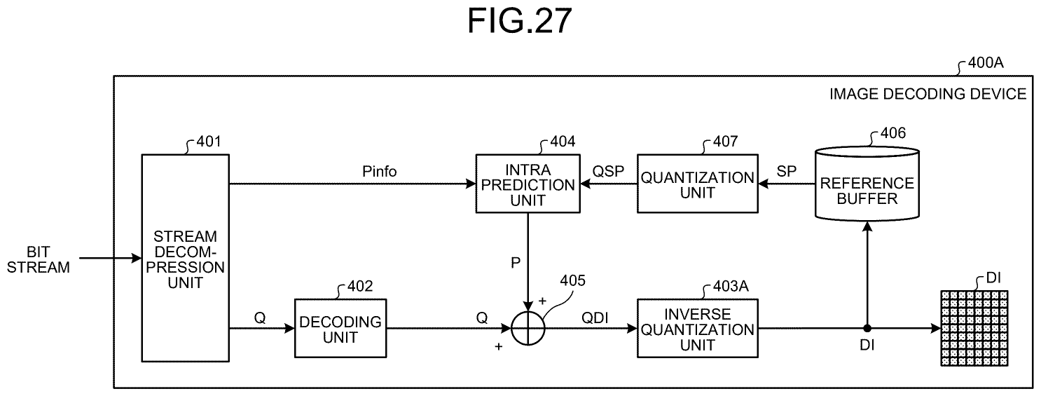

As described above, when the reference pixels SP are extracted from the image data QGD, any of the high-frequency vectors SP_H(VC), the low-frequency components SP_L, and the high-frequency component X_H serves as information based on the quantized data QD. That is, the learning processing in the learning instrument 100 is based on the quantized data QD. Furthermore, as a result, processing of each of the image encoding device 300 mounted with the inference instrument 200 and the image decoding device 400 mounted with the inference instrument 200 is changed to processing corresponding to quantization. In the following description, this point will be described in more detail with reference to FIGS. 26 and 27.

### 4. Variations According to Second Embodiment

### 4-1. Information Processing (1) Accompanying Quantization

First, an operation example of the image encoding device 300 accompanying the quantization described in FIG. 25 will be described with reference to FIG. 26. FIG. 26 is a block diagram illustrating an overall configuration example of the image encoding device 300 according to a variation of the second embodiment.

FIG. 26 illustrates an image encoding device 300A in an example of the image encoding device 300 according to the variation. The image encoding device 300A further includes a quantization unit 311, a quantization unit 312, and a reference buffer 313 as compared with the image encoding device 300 in FIG. 14. Furthermore, the image encoding device 300A includes an inverse quantization unit 307A instead of the quantization unit 305 and the inverse quantization unit 307 of the image encoding device 300 in FIG. 14. That is, in the image encoding device 300A, the quantization unit 305 and the inverse quantization unit 307 may be eliminated.

### Quantization Unit 311

When the original image data GD is input, the quantization unit 311 generates image data QGD by performing quantization processing on pixels constituting the input original image data GD. Furthermore, the quantization unit 311 transmits the image data QGD to the prediction mode determination unit 301 and the subtraction unit 303.

### Quantization Unit 312

The quantization unit 312 performs quantization processing on the reference pixels SP transmitted by the reference buffer 313. Specifically, the quantization unit 312 obtains reference pixels QSP as the quantized reference pixels SP by performing quantization processing on the reference pixels SP. Furthermore, the quantization unit 312 transmits the reference pixels QSP to the prediction mode determination unit 301 and the intra prediction unit 302.

### Reference Buffer 313

The reference buffer 313 accumulates pieces of decoded image data DI generated by the inverse quantization unit 307A to be described later. For example, the reference buffer 313 may accumulate the pieces of decoded image data DI in a state of being rearranged in an encoding order. Furthermore, the reference buffer 313 may extract the reference pixels SP within the reference range R from the pieces of decoded image data DI, and transmit the extracted reference pixels SP to the quantization unit 312.

In the following description, processing performed by other processing units in the image encoding device 300 accompanying the quantization unit 311, the quantization unit 312, and the reference buffer 313 will also be described.

### Prediction Mode Determination Unit 301

The prediction mode determination unit 301 performs intra prediction processing on all candidate intra prediction modes by using the reference pixels QSP transmitted by the quantization unit 312. Moreover, the prediction mode determination unit 301 calculates cost function values of the intra prediction modes, and determines, as the optimum intra prediction mode, an intra prediction mode with the calculated minimum cost function value, that is, an intra prediction mode with the best encoding efficiency. Furthermore, the prediction mode determination unit 301 transmits prediction mode information Pinfo to the intra prediction unit 302 and the stream generation unit 309. The prediction mode information Pinfo indicates the determined intra prediction mode.

### Intra Prediction Unit 302

The intra prediction unit 302 performs processing related to generation of a predicted image QP in accordance with a prediction mode indicated by the prediction mode information Pinfo. For example, the intra prediction unit 302 calculates intra prediction values of the reference pixels QSP by performing the intra prediction processing by using the prediction mode indicated by the prediction mode information Pinfo and the reference pixels QSP transmitted by the quantization unit 312. Then, the intra prediction unit 302 generates the predicted image QP based on the intra prediction values. The predicted image QP corresponds to the quantized predicted image P generated by the intra prediction unit 302 in FIG. 14.

Furthermore, the intra prediction unit 302 transmits the predicted image QP to the subtraction unit 303 and the addition unit 304.

### Subtraction Unit 303

The subtraction unit 303 calculates prediction error data Q, which is the difference between the image data QGD and the predicted image QP (Q=QGD−QP), and transmits the calculated prediction error data Q to the addition unit 304 and the entropy encoding unit 306. Here, FIG. 14 illustrates an example in which the quantization unit 305 quantizes the prediction error data D to obtain the quantized data Q. In an example of FIG. 26, however, the prediction error data Q is calculated from quantized information, specifically, the image data QGD and the predicted image QP, and thus substantially corresponds to the quantized data Q described in FIG. 14. Furthermore, the subtraction unit 303 transmits the prediction error data Q to the addition unit 304 and the entropy encoding unit 306.

### Addition Unit 304

The addition unit 304 adds the prediction error data Q and predicted image QP to generate quantized decoded image data QDI. Here, in the example of FIG. 14, the inverse quantization unit 307 restores the prediction error data D by inversely quantizing the quantized data Q. The addition unit 304 adds the prediction error data D and the predicted image P to generate the decoded image data DI. In the example of FIG. 26, however, the inverse quantization unit 307 is not provided. The addition unit 304 once generates the quantized decoded image data QDI from the quantized information, specifically, the prediction error data Q and the predicted image QP. Furthermore, the addition unit 304 transmits the decoded image data QDI to the inverse quantization unit 307A.

### Inverse Quantization Unit 307A

As described above, the decoded image data QDI is quantized. Therefore, the inverse quantization unit 307A inversely quantizes the decoded image data QDI. Specifically, the inverse quantization unit 307A obtains inversely quantized original decoded image data DI by performing inverse quantization processing on the decoded image data QDI. Furthermore, the inverse quantization unit 307A accumulates pieces of decoded image data DI in the reference buffer 313.

### Entropy Encoding Unit 306

The entropy encoding unit 306 reversibly encodes prediction error data Q (quantized data Q), and transmits the reversibly encoded data RC to the stream generation unit 309.

### Stream Generation Unit 309

The stream generation unit 309 multiplexes the reversibly encoded data RC to generate an encoded bit stream. Furthermore, the stream generation unit 309 reversibly encodes the prediction mode information Pinfo, and adds the prediction mode information Pinfo to header information of the encoded bit stream.

### 4-2. Information Processing (2) Accompanying Quantization

Next, an operation example of the image decoding device 400 accompanying the quantization described in FIG. 25 will be described with reference to FIG. 27. FIG. 27 is a block diagram illustrating an overall configuration example of the image decoding device 400 according to the variation of the second embodiment.

FIG. 27 illustrates an image decoding device 400A in an example of the image decoding device 400 according to the variation. The image decoding device 400A further includes a quantization unit 407 as compared with the image decoding device 400 in FIG. 19. Furthermore, the image decoding device 400A includes an inverse quantization unit 403A instead of the inverse quantization unit 403 of the image encoding device 300 in FIG. 19. That is, in the image decoding device 400A, the inverse quantization unit 403 may be eliminated.

### Stream Decompression Unit 401

The stream decompression unit 401 uses an encoded bit stream as input, and separates encoded information by a method corresponding to an encoding method of the entropy encoding unit 306 of the image encoding device 300A. For example, the stream decompression unit 401 derives parameters by performing variable-length decoding on the reversibly encoded data RC from a bit string of the encoded bit stream. The parameters include the header information, the prediction mode information Pinfo, and the prediction error data Q (quantized data Q).

Therefore, the stream decompression unit 401 transmits the prediction mode information Pinfo to the intra prediction unit 404, and transmits the prediction error data Q to the decoding unit 402.

### Decoding Unit 402

Here, the decoding unit 402 decodes the prediction error data Q by a method corresponding to the encoding method of the entropy encoding unit 306. Here, in the example of FIG. 19, an example has been described in which the decoding unit 402 decodes the quantized data Q corresponding to the prediction error data Q and the inverse quantization unit 403 inversely quantizes the quantized data Q. In an example of FIG. 27, however, the inverse quantization unit 403 is not provided, so that the prediction error data Q decoded by the decoding unit 402 is transmitted to the addition unit 405 as it is without being inversely quantized.

### Quantization Unit 407

The quantization unit 407 performs quantization processing on the reference pixels SP transmitted by the reference buffer 406. Specifically, the quantization unit 312 obtains reference pixels QSP as the quantized reference pixels SP by performing quantization processing on the reference pixels SP. Furthermore, the quantization unit 407 transmits the reference pixels QSP to the intra prediction unit 404.

### Intra Prediction Unit 404

The intra prediction unit 404 performs processing related to generation of a predicted image QP in accordance with a prediction mode indicated by the prediction mode information Pinfo. For example, the intra prediction unit 404 calculates intra prediction values of the reference pixels QSP by performing the intra prediction processing by using the prediction mode indicated by the prediction mode information Pinfo and the reference pixels QSP transmitted by the quantization unit 407. Then, the intra prediction unit 404 generates the predicted image QP based on the intra prediction values. The predicted image QP corresponds to the quantized predicted image P generated by the intra prediction unit 404 in FIG. 19. Furthermore, the intra prediction unit 404 transmits the predicted image QP to the addition unit 405.

### Addition Unit 405

The addition unit 405 adds the prediction error data Q and predicted image QP to generate quantized decoded image data QDI. Here, in the example of FIG. 19, the inverse quantization unit 403 acquires the prediction error data D by inversely quantizing the quantized data Q decoded by the decoding unit 402. The addition unit 304 adds the prediction error data D and the predicted image P to generate the decoded image data DI. In the example of FIG. 27, however, the inverse quantization unit 403 is not provided. The addition unit 405 once generates the quantized decoded image data QDI from the quantized information, specifically, the prediction error data Q and the predicted image QP. Furthermore, the addition unit 405 transmits the decoded image data QDI to the inverse quantization unit 403A.

### Inverse Quantization Unit 404A

As described above, the decoded image data QDI is quantized. Therefore, an inverse quantization unit 404A inversely quantizes the decoded image data QDI. Specifically, the inverse quantization unit 404A obtains inversely quantized original decoded image data DI by performing inverse quantization processing on the decoded image data QDI. Furthermore, the inverse quantization unit 404A accumulates pieces of decoded image data DI in the reference buffer 406.

### Reference Buffer 406

The reference buffer 406 accumulates pieces of decoded image data DI generated by the inverse quantization unit 404A. For example, the reference buffer 406 may accumulate the pieces of decoded image data DI in a state of being rearranged in an encoding order. Furthermore, the reference buffer 406 may extract the reference pixels SP within the reference range R from the pieces of decoded image data DI, and transmit the extracted reference pixels SP to the quantization unit 407.

### 5. Effects

According to the learning instrument 100, the inference instrument 200, the image encoding device 300, and the image decoding device 400 of the proposed technique of the present disclosure, prediction accuracy can be improved particularly for an edge and a high-frequency component as compared with that in a conventional machine learning algorithm.

### 6. Hardware Configuration Example

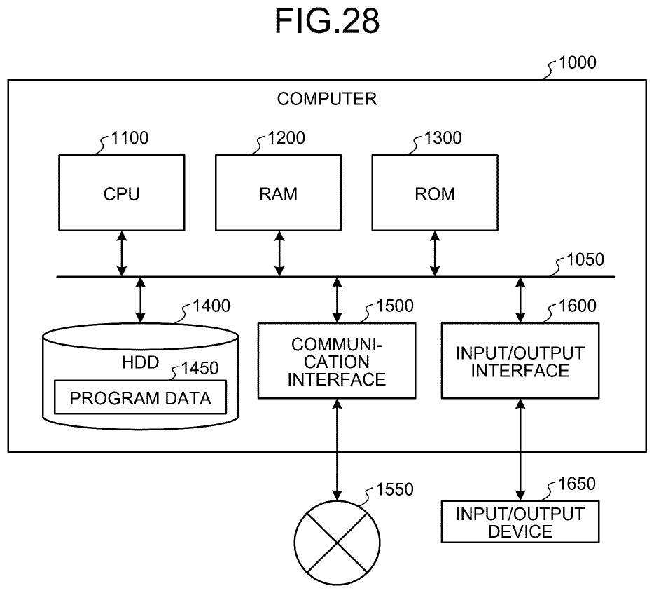

A hardware configuration example of a computer corresponding to a device such as the learning instrument 100, the inference instrument 200, the image encoding device 300, and the image decoding device 400 according to the above-described embodiments will be described with reference to FIG. 28. FIG. 28 is a block diagram illustrating a hardware configuration example of a computer corresponding to a device according to the embodiments and the variations of the present disclosure. Note that FIG. 28 illustrates an example of the hardware configuration of a computer corresponding to a device according to the embodiments and the variations of the present disclosure. The hardware configuration is not required to be limited to the configuration in FIG. 28.

As illustrated in FIG. 28, a computer 1000 includes a central processing unit (CPU) 1100, a random access memory (RAM) 1200, a read only memory (ROM) 1300, a hard disk drive (HDD) 1400, a communication interface 1500, and an input/output interface 1600. Units of the computer 1000 are connected by a bus 1050.

The CPU 1100 operates based on a program stored in the ROM 1300 or the HDD 1400, and controls the units. For example, the CPU 1100 develops a program stored in the ROM 1300 or the HDD 1400 on the RAM 1200, and executes processing corresponding to various programs.

The ROM 1300 stores a boot program such as a basic input output system (BIOS) executed by the CPU 1100 at the time when the computer 1000 is started, a program depending on hardware of the computer 1000, and the like.

The HDD 1400 is a computer-readable recording medium that non-transiently records a program to be executed by the CPU 1100, data to be used by the program, and the like. Specifically, the HDD 1400 records program data 1450. The program data 1450 is an example of a program for performing the processing method according to the embodiments and the variations of the present disclosure and data used by the program.

The communication interface 1500 connects the computer 1000 with an external network 1550 (e.g., Internet). For example, the CPU 1100 receives data from another device, and transmits data generated by the CPU 1100 to the other device via the communication interface 1500.

The input/output interface 1600 connects an input/output device 1650 with the computer 1000. For example, the CPU 1100 receives data from an input device such as a keyboard and a mouse via the input/output interface 1600. Furthermore, the CPU 1100 transmits data to an output device such as a display device, a speaker, and a printer via the input/output interface 1600. Furthermore, the input/output interface 1600 may function as a medium interface that reads a program and the like recorded in a predetermined recording medium. The medium includes, for example, an optical recording medium such as a digital versatile disc (DVD) and a phase change rewritable disk (PD), a magneto-optical recording medium such as a magneto-optical disk (MO), a tape medium, a magnetic recording medium, a semiconductor memory, and the like.

For example, when the computer 1000 functions as a device (learning instrument 100 in example) according to the embodiments and the variations of the present disclosure, the CPU 1100 of the computer 1000 implements various processing functions executed by the processing units in FIG. 3 by executing an information processing program loaded on the RAM 1200. That is, the CPU 1100, the RAM 1200, and the like implement the learning method performed by the device (learning instrument 100 in example) according to the embodiments and the variations of the present disclosure in cooperation with software (program loaded on RAM 1200).

Furthermore, when the computer 1000 functions as a device (inference instrument 200 in example) according to the embodiments and the variations of the present disclosure, the CPU 1100 of the computer 1000 implements various processing functions executed by the processing units in FIG. 10 by executing an information processing program loaded on the RAM 1200. That is, the CPU 1100, the RAM 1200, and the like implement the inference method performed by the device (inference instrument 200 in example) according to the embodiments and the variations of the present disclosure in cooperation with software (program loaded on RAM 1200).

### 7. Conclusion

Although the embodiments of the present disclosure have been described above, the technical scope of the present disclosure is not limited to the above-described embodiments as it is, and various modifications can be made without departing from the gist of the present disclosure. Furthermore, components of the embodiments and the variations may be appropriately combined.

Furthermore, the effects in the embodiments described in the present specification are merely examples and not limitations. Other effects may be exhibited.

Note that the present disclosure may also have the configurations as follows.
(1) A learning device comprising:
   a first filter processing unit that performs component separation on frequency components included in reference pixels based on feature vectors of the reference pixels in a vicinity of a pixel to be predicted in image data; and
   a learning unit that learns a model that outputs a prediction value of the pixel to be predicted by using, as learning data, a set of a high-frequency vector, which is a feature vector of a high-frequency component among frequency components obtained by the component separation, and high-frequency information, which relates to a high-frequency component among frequency components included in the pixel to be predicted.
(2) The learning device according to the above (1),
   wherein the first filter processing unit acquires the high-frequency information by subtracting a low-frequency component among the frequency components obtained by the component separation from the frequency components included in the pixel to be predicted.
(3) The learning device according to the above (2),
   wherein the first filter processing unit performs component separation on the frequency components into a component in a high-frequency band and a component in a low-frequency band based on the feature vectors, acquires a high-frequency vector, which is a feature vector of a high-frequency component, which is the component in the high-frequency band among components in two frequency bands obtained by the component separation, and subtracts a low-frequency component, which is the component in the low-frequency band, from the frequency components included in the pixel to be predicted.
(4) The learning device according to above the (2),
   wherein the first filter processing unit performs component separation on the frequency components into a component in a high-frequency band, a component in a medium-frequency band, and a component in a low-frequency band based on the feature vectors, determines the component in the medium-frequency band as a high-frequency component and acquires a high-frequency vector, which is a feature vector of the high-frequency component by excluding the component in the high-frequency band among components in three frequency bands obtained by the component separation, and subtracts a low-frequency component, which is the component in the low-frequency band, from the frequency components included in the pixel to be predicted.
(5) The learning device according to above the (1),
   wherein the first filter processing unit performs component separation on the frequency components included in the reference pixels by using, as filter information, a representative value representing the feature vectors of the reference images.
(6) The learning device according to the above (5),
   wherein the first filter processing unit performs component separation on the frequency components included in the reference pixels by using, as the filter information, an average value obtained by averaging the feature vectors of the reference pixels, as the representative value.
(7) The learning device according to the above (5),
   wherein the first filter processing unit separates the representative value as a low-frequency component among the frequency components included in the reference pixels, and separates differences between the representative value and the feature vectors of the reference pixels as high-frequency components among the frequency components included in the reference pixels.
(8) The learning device according to the above (1),
   wherein the model is a machine learning model, and
   the learning unit uses the high-frequency vector as an explanatory variable, and adjusts a parameter of the machine learning model based on the learning data in which the high-frequency information is used as an objective variable.
(9) An inference device that performs inference processing by using a learned model learned by a learning device, the inference device comprising:
   a second filter processing unit that performs component separation on frequency components included in reference pixels based on feature vectors of the reference pixels in a vicinity of a pixel to be predicted in image data; and
   an intra prediction unit that performs intra prediction for a pixel value of the pixel to be predicted based on a prediction value output by the learned model by using, as input, a high-frequency vector, which is a feature vector of a high-frequency component among frequency components obtained by the component separation.
(10) The inference device according to the above (9),
   wherein the second filter processing unit performs component separation on the frequency components included in the reference pixels in accordance with a content of processing performed by the first filter processing unit of the learning device.
(11) The inference device according to the above (10),
   wherein the second filter processing unit performs component separation on the frequency components into a component in a high-frequency band and a component in a low-frequency band based on the feature vectors, and acquires a high-frequency vector, which is a feature vector of a high-frequency component, which is the component in the high-frequency band among components in two frequency bands obtained by the component separation.
(12) The inference device according to the above (10),
   wherein the second filter processing unit performs component separation on the frequency components into a component in a high-frequency band, a component in a medium-frequency band, and a component in a low-frequency band based on the feature vectors, and determines the component in the medium-frequency band as a high-frequency component and acquires a high-frequency vector, which is a feature vector of the high-frequency component by excluding the component in the high-frequency band among components in three frequency bands obtained by the component separation.
(13) The inference device according to the above (9),
   wherein the learning device acquires high-frequency information, which relates to a high-frequency component among frequency components included in the pixel to be predicted by subtracting a low-frequency component among the frequency components obtained by the component separation from the frequency components included in the pixel to be predicted, and
   the intra prediction unit predicts a value obtained by adding the low-frequency component used for subtraction to the prediction value as a pixel value of the pixel to be predicted.
(14) A learning method to be executed by a learning device, comprising:
   a filter processing step of performing component separation on frequency components included in reference pixels based on feature vectors of the reference pixels in a vicinity of a pixel to be predicted in image data; and
   a learning step of learning a model that outputs a prediction value of the pixel to be predicted by using, as learning data, a set of a high-frequency vector, which is a feature vector of a high-frequency component among frequency components obtained by the component separation, and high-frequency information, which relates to a high-frequency component among frequency components included in the pixel to be predicted.
(15) An inference method to be executed by a learning device that performs inference processing by using a learned model learned by a learning device, the inference method comprising:
   a second filter processing step of performing component separation on frequency components included in reference pixels based on feature vectors of the reference pixels in a vicinity of a pixel to be predicted in image data; and
   an intra prediction process of performing intra prediction for a pixel value of the pixel to be predicted based on a prediction value output by the learned model by using, as input, a high-frequency vector, which is a feature vector of a high-frequency component among frequency components obtained by the component separation.
(16) An encoding device including an inference device that performs inference processing by using a learned model learned by a learning device,
   the inference device comprising:
   a second filter processing unit that performs component separation on frequency components included in reference pixels based on feature vectors of the reference pixels in a vicinity of a pixel to be predicted in image data; and
   an intra prediction unit that performs intra prediction for a pixel value of the pixel to be predicted based on a prediction value output by the learned model by using, as input, a high-frequency vector, which is a feature vector of a high-frequency component among frequency components obtained by the component separation.
(17) A decoding device including an inference device that performs inference processing by using a learned model learned by a learning device,
   the inference device comprising:
   a second filter processing unit that performs component separation on frequency components included in reference pixels based on feature vectors of the reference pixels in a vicinity of a pixel to be predicted in image data; and
   an intra prediction unit that performs intra prediction for a pixel value of the pixel to be predicted based on a prediction value output by the learned model by using, as input, a high-frequency vector, which is a feature vector of a high-frequency component among frequency components obtained by the component separation.

### REFERENCE SIGNS LIST

1 IMAGE PROCESSING SYSTEM
11 IMAGE PROCESSING SYSTEM
100 LEARNING INSTRUMENT
101 PIXEL SCAN UNIT
102 FILTER PROCESSING UNIT
103 DIFFERENCE CALCULATION UNIT
104 LEARNING UNIT
200 INFERENCE INSTRUMENT
201 FILTER PROCESSING UNIT
202 INFERENCE UNIT
203 ADDITION UNIT
300 IMAGE ENCODING DEVICE
400 IMAGE DECODING DEVICE

What is claimed is:

1. A learning device comprising:
a first filter processing unit that performs component separation on frequency components included in reference pixels based on feature vectors of the reference pixels in a vicinity of a pixel to be predicted in image data; and
a learning unit that learns a model that outputs a prediction value of the pixel to be predicted by using, as learning data, a set of a high-frequency vector, which is a feature vector of a high-frequency component among frequency components obtained by the component separation, and high-frequency information, which relates to a high-frequency component among frequency components included in the pixel to be predicted.

2. The learning device according to claim 1,
wherein the first filter processing unit acquires the high-frequency information by subtracting a low-frequency component among the frequency components obtained by the component separation from the frequency components included in the pixel to be predicted.

3. The learning device according to claim 2,
wherein the first filter processing unit performs component separation on the frequency components into a component in a high-frequency band and a component in a low-frequency band based on the feature vectors, acquires a high-frequency vector, which is a feature vector of a high-frequency component, which is the component in the high-frequency band among components in two frequency bands obtained by the component separation, and subtracts a low-frequency component, which is the component in the low-frequency band, from the frequency components included in the pixel to be predicted.

4. The learning device according to claim 2,
wherein the first filter processing unit performs component separation on the frequency components into a component in a high-frequency band, a component in a medium-frequency band, and a component in a low-frequency band based on the feature vectors, determines the component in the medium-frequency band as a high-frequency component and acquires a high-frequency vector, which is a feature vector of the high-frequency component by excluding the component in the high-frequency band among components in three frequency bands obtained by the component separation, and subtracts a low-frequency component, which is the component in the low-frequency band, from the frequency components included in the pixel to be predicted.

5. The learning device according to claim 1,
wherein the first filter processing unit performs component separation on the frequency components included in the reference pixels by using, as filter information, a representative value representing the feature vectors of the reference images.

6. The learning device according to claim 5,
wherein the first filter processing unit performs component separation on the frequency components included in the reference pixels by using, as the filter information, an average value obtained by averaging the feature vectors of the reference pixels, as the representative value.

7. The learning device according to claim 5,
wherein the first filter processing unit separates the representative value as a low-frequency component among the frequency components included in the reference pixels, and separates differences between the representative value and the feature vectors of the reference pixels as high-frequency components among the frequency components included in the reference pixels.

8. The learning device according to claim 1,
wherein the model is a machine learning model, and
the learning unit uses the high-frequency vector as an explanatory variable, and adjusts a parameter of the machine learning model based on the learning data in which the high-frequency information is used as an objective variable.

9. An inference device that performs inference processing by using a learned model learned by a learning device, the inference device comprising:
a second filter processing unit that performs component separation on frequency components included in reference pixels based on feature vectors of the reference pixels in a vicinity of a pixel to be predicted in image data; and
an intra prediction unit that performs intra prediction for a pixel value of the pixel to be predicted based on a prediction value output by the learned model by using, as input, a high-frequency vector, which is a feature vector of a high-frequency component among frequency components obtained by the component separation.

10. The inference device according to claim 9,
wherein the second filter processing unit performs component separation on the frequency components included in the reference pixels in accordance with a content of processing performed by the first filter processing unit of the learning device.

11. The inference device according to claim 10,
wherein the second filter processing unit performs component separation on the frequency components into a component in a high-frequency band and a component in a low-frequency band based on the feature vectors, and acquires a high-frequency vector, which is a feature vector of a high-frequency component, which is the component in the high-frequency band among components in two frequency bands obtained by the component separation.

12. The inference device according to claim 10,
wherein the second filter processing unit performs component separation on the frequency components into a component in a high-frequency band, a component in a medium-frequency band, and a component in a low-frequency band based on the feature vectors, and determines the component in the medium-frequency band as a high-frequency component and acquires a high-frequency vector, which is a feature vector of the high-frequency component by excluding the component in the high-frequency band among components in three frequency bands obtained by the component separation.

13. The inference device according to claim 9,
wherein the learning device acquires high-frequency information, which relates to a high-frequency component among frequency components included in the pixel to be predicted by subtracting a low-frequency component among the frequency components obtained by the component separation from the frequency components included in the pixel to be predicted, and
the intra prediction unit predicts a value obtained by adding the low-frequency component used for subtraction to the prediction value as a pixel value of the pixel to be predicted.

14. A learning method to be executed by a learning device, comprising:
a filter processing step of performing component separation on frequency components included in reference pixels based on feature vectors of the reference pixels in a vicinity of a pixel to be predicted in image data; and
a learning step of learning a model that outputs a prediction value of the pixel to be predicted by using, as learning data, a set of a high-frequency vector, which is a feature vector of a high-frequency component among frequency components obtained by the component separation, and high-frequency information, which relates to a high-frequency component among frequency components included in the pixel to be predicted.

15. An inference method to be executed by a learning device that performs inference processing by using a learned model learned by a learning device, the inference method comprising:
a second filter processing step of performing component separation on frequency components included in reference pixels based on feature vectors of the reference pixels in a vicinity of a pixel to be predicted in image data; and
an intra prediction process of performing intra prediction for a pixel value of the pixel to be predicted based on a prediction value output by the learned model by using, as input, a high-frequency vector, which is a feature vector of a high-frequency component among frequency components obtained by the component separation.

16. An encoding device including an inference device that performs inference processing by using a learned model learned by a learning device,
the inference device comprising:
a second filter processing unit that performs component separation on frequency components included in reference pixels based on feature vectors of the reference pixels in a vicinity of a pixel to be predicted in image data; and
an intra prediction unit that performs intra prediction for a pixel value of the pixel to be predicted based on a prediction value output by the learned model by using, as input, a high-frequency vector, which is a feature vector of a high-frequency component among frequency components obtained by the component separation.

17. A decoding device including an inference device that performs inference processing by using a learned model learned by a learning device,
the inference device comprising:
a second filter processing unit that performs component separation on frequency components included in reference pixels based on feature vectors of the reference pixels in a vicinity of a pixel to be predicted in image data; and
an intra prediction unit that performs intra prediction for a pixel value of the pixel to be predicted based on a prediction value output by the learned model by using, as input, a high-frequency vector, which is a feature vector of a high-frequency component among frequency components obtained by the component separation.
